(19) United States
(12) Patent Application Publication
(10) Pub. No.: US 2013/0322076 A1
(43) Pub. Date: Dec. 5, 2013

(54) LIGHT BULB WITH PLANAR LIGHT GUIDES

(71) Applicant: Rambus Delaware LLC, Brecksville, OH (US)

(72) Inventors: Jeffery R. Parker, Richfield, OH (US); Timothy A. McCollum, Avon Lake, OH (US); Fumitomo Hide, San Jose, CA (US); Gregg M. Podojil, Brecksville, OH (US); Ian Hardcastle, Santa Cruz, CA (US)

(21) Appl. No.: 13/905,449

(22) Filed: May 30, 2013

Related U.S. Application Data
(60) Provisional application No. 61/653,092, filed on May 30, 2012.

(51) Int. Cl. F21V 8/00

(52) U.S. Cl. CPC G02B 6/0075
USPC 362/240

(57) ABSTRACT

A light bulb includes light guides extending in a direction having a radial component with respect to a longitudinal axis, each light guide including a light input edge, opposed major surfaces, and light extracting elements at least one of the opposed major surfaces. In one embodiment, the light guides are disposed about an axial heat sink, and for each light guide, a respective light source is mounted to the axial heat sink to edge light the light guide such that light from the light source propagates in the light guide by total internal reflection. In another embodiment, a housing is at an end of the light guides, and for each light guide, a respective light source is mounted to the housing to edge light the light guide such that light from the light source propagates in the light guide by total internal reflection.

### RELATED APPLICATION DATA

This application claims the benefit of U.S. Provisional Patent Application No. 61/653,092, filed May 30, 2012, the disclosure of which is incorporated herein by reference in its entirety.

### BACKGROUND

Energy efficiency has become an area of interest for energy consuming devices. One class of energy consuming devices is incandescent light bulbs. Light emitting diode (LED) based light bulbs show promise as an energy-efficient, longer-lived and mercury-free replacement for incandescent light bulbs and compact fluorescent lamps (CFL). But light output distribution is an issue for lighting devices that use LEDs or similar light sources. Furthermore, for many lighting devices that use LEDs or similar light sources, the energy-saving promise of LED-based light bulbs cannot be realized without an effective way of dissipating heat generated by the LEDs.

### BRIEF DESCRIPTION OF THE DRAWINGS

FIG. 1 is a perspective view of an exemplary light bulb.

FIG. 2 is a side view of the light bulb shown in FIG. 1.

FIG. 3 is a perspective view showing another exemplary light bulb.

FIG. 4 is a top view showing part of the light bulb shown in FIG. 3 viewed from the second end of the axial heat sink.

FIGS. 5-9 are side views showing other exemplary light bulbs.

FIG. 10 is a perspective view showing another exemplary light bulb.

FIG. 11 is a partially cut away side view showing part of another exemplary light bulb.

FIG. 12 is a side view showing part of another exemplary light bulb.

FIG. 13 is a perspective view showing another exemplary light bulb.

FIG. 14 is a side view of the light bulb shown in FIG. 13.

FIG. 15 is a schematic view showing the light source arrangement of the light bulb shown in FIG. 13 viewed from the end of the light bulb distal the housing.

FIG. 16 is a schematic view showing the light guide arrangement of the light bulb shown in FIG. 13 viewed from the end of the light bulb distal the housing.

FIGS. 17 and 18 are schematic views showing light guide arrangements of other exemplary light bulbs viewed from the end of the light bulb distal the housing.

FIGS. 19 and 20 are perspective views showing other exemplary light bulbs.

FIG. 21 is an exploded perspective view showing part of another exemplary light bulb.

FIG. 22 is a side view showing part of the light bulb shown in FIG. 21.

FIG. 23 is a side view showing part of another exemplary light bulb.

FIG. 24 is a perspective view showing another exemplary light bulb.

FIG. 25 is a side view of the light bulb shown in FIG. 24.

FIG. 26 is a perspective view showing another exemplary light bulb.

FIG. 27 is a side view of the light bulb shown in FIG. 26.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface.

In accordance with one embodiment, a light bulb includes an axial heat sink including an outer major surface extending between a first end and a second end. The axial heat sink defines a longitudinal axis. Planar light guides are disposed about the axial heat sink. Each of the light guides includes a respective light input edge adjacent the outer major surface of the axial heat sink, respective opposed major surfaces extending from the light input edge in a direction having a radial component with respect to the longitudinal axis, and light extracting elements at least one of the opposed major surfaces to extract light through at least one of the opposed major surfaces of the light guide. For each light guide, a respective light source is mounted to the axial heat sink to edge light the light guide such that light from the light source propagates in the light guide by total internal reflection at the opposed major surfaces.

In accordance with another embodiment, a light bulb includes a housing having a mounting surface, a normal to the mounting surface defining a longitudinal axis, and planar light guides coupled to the housing. Each light guide includes respective opposed major surfaces extending in a direction having a radial component with respect to the longitudinal axis, a light input edge extending between the major surfaces at an end of the light guide proximate the housing, and light extracting elements at least one of the major surfaces to extract light from the light guide through at least one of the major surfaces. For each light guide, a respective light source is mounted to the housing adjacent the light input edge of the light guide to edge light the light guide such that light from the light source propagates in the light guide by total internal reflection at the opposed major surfaces of the light guide.

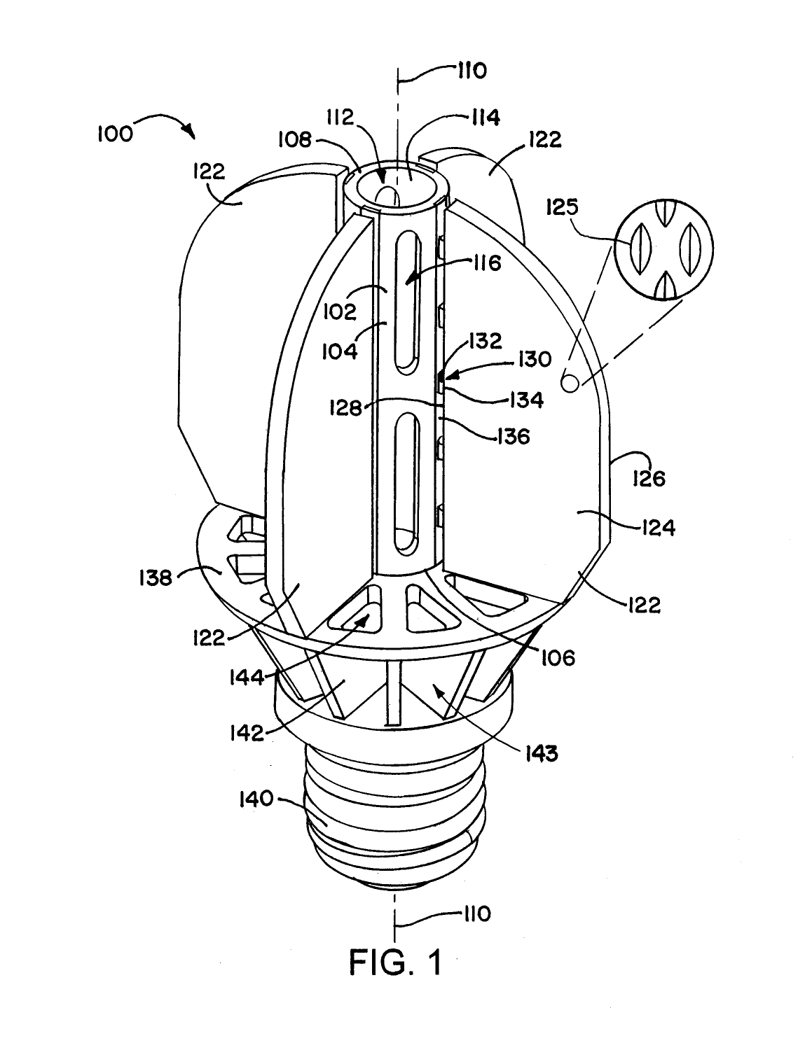

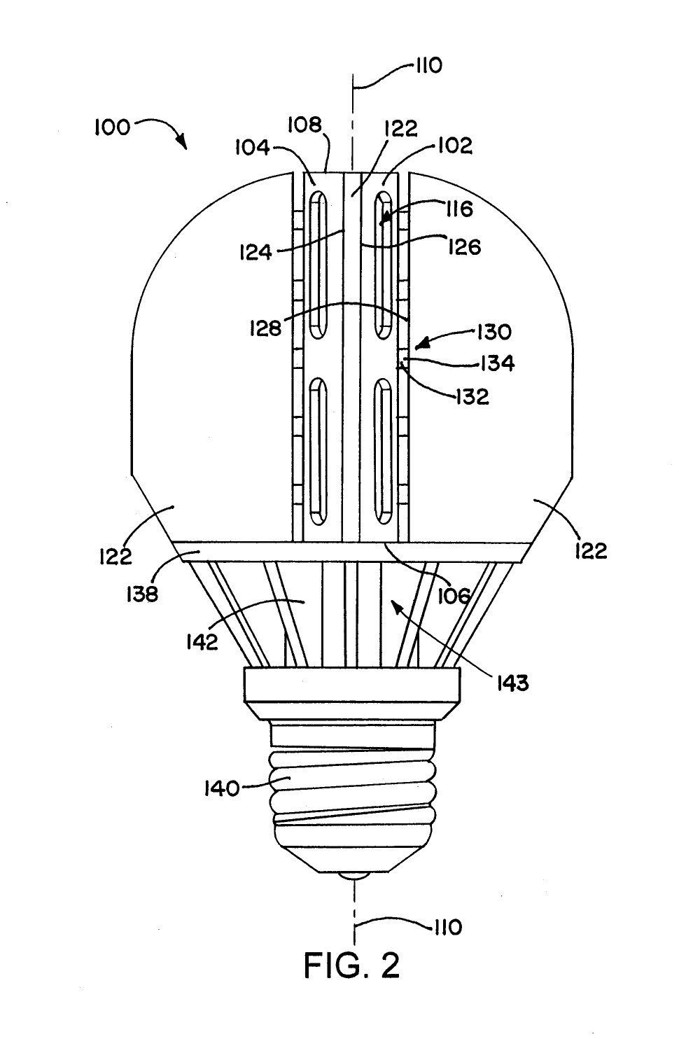

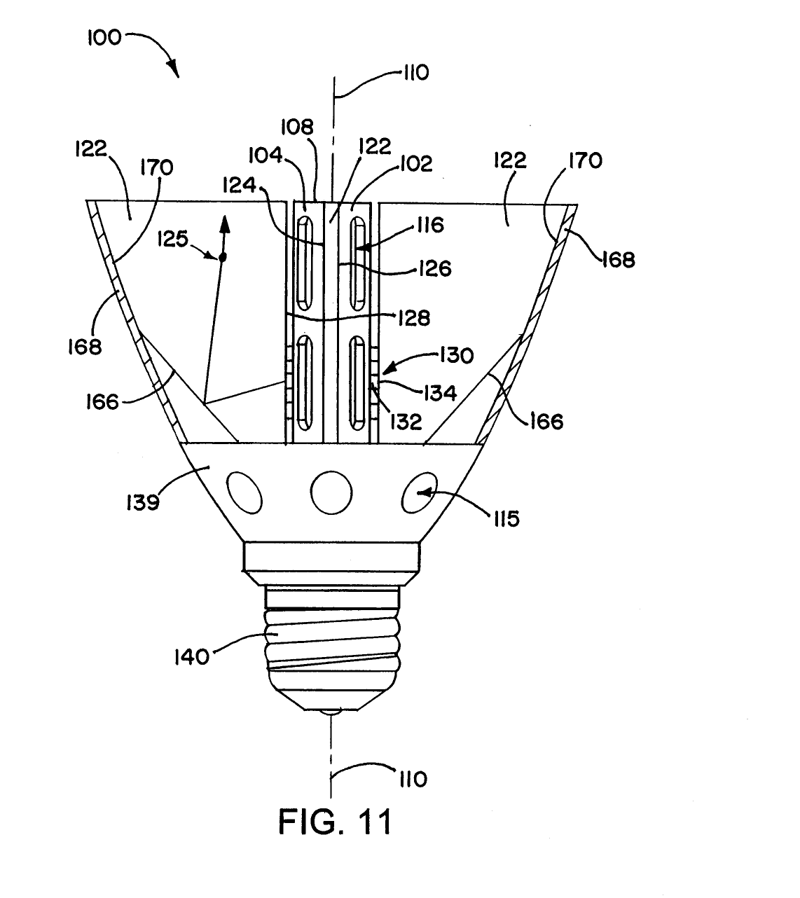

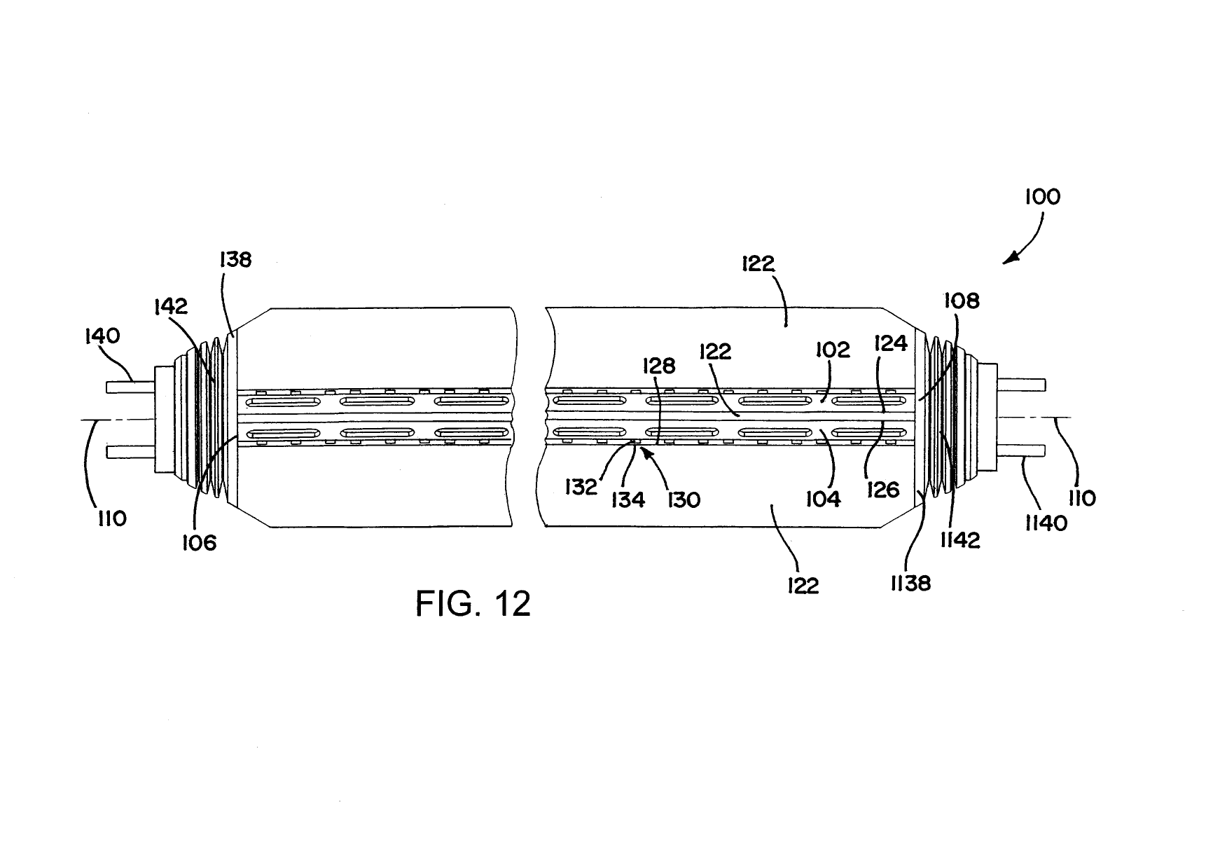

With initial reference to FIGS. 1 and 2, an exemplary embodiment of the light bulb is shown at 100. References in this disclosure to a “light bulb” are meant to broadly encompass light-producing devices that fit into and engage any of various fixtures used for mechanically mounting the light-producing device and for providing electrical power thereto. Examples of such fixtures include, without limitation, a screw-in fixture for engaging an Edison light bulb base, a bayonet fixture for engaging a bayonet light bulb base, and a bi-pin fixture for engaging a bi-pin light bulb base. Thus the term “light bulb,” by itself, does not provide any limitation on the shape of the light-producing device, or the mechanism by which light is produced from electric power. In the exemplary embodiment shown in FIGS. 1 and 2, the light bulb conforms to the outer envelope of an A19 light bulb. In other embodiments, the light bulb conforms to the outer envelope of a PAR lamp (FIG. 11) or the outer envelope of a T8, T10, or T12 tube light (FIG. 12). Also, the light bulb need not have an enclosed envelope forming an environment for light generation. The light bulb may conform to American National Standards Institute (ANSI) or other standards for electric lamps, but the light bulb does not necessarily have to have this conformance.

The light bulb 100 includes an axial heat sink 102 having an outer major surface 104 extending between a first end 106 and a second end 108, the axial heat sink defining a longitudinal axis 110. The axial heat sink 102 is configured as an open-ended hollow body surrounding an internal volume 112 and includes an inner major surface 114 opposite the outer major surface 104, the inner major surface 114 extending between the first end 106 and the second end 108. In some embodiments, the internal volume 112 of the axial heat sink 112 houses one or more components of the light source 130. In an example, a light source driver (not shown) is housed within the internal volume 112. In other embodiments, the axial heat sink 102 is a solid article and lacks an inner major surface 114.

In the example shown, the axial heat sink 102 is cylindrical in shape. In other embodiments, the axial heat sink 102 is conical, pyramidal, frustoconical or frustopyramidal in shape, a prism, bell-shaped, hourglass-shaped, bulbous, or another suitable shape.

Elongate, axial through-slots 116 extend radially through the axial heat sink 102 to allow air to flow therethrough into and/or out of the internal volume 112 of the axial heat sink 102. The through-slots 116 improve the dissipation of heat generated by the light source 130 by providing a path for air flow and convective cooling. In an example wherein the light bulb 100 is operated with the longitudinal axis 110 horizontal, the through-slots 116 allow cooling air to flow through the internal volume 112 of the axial heat sink 102, the air flow direction having a vertical vector component. In an example wherein the light bulb 100 is operated with the longitudinal axis 110 vertical, the through-slots 116 allow cooling air to enter therethrough, flow through the internal volume 112 of the axial heat sink 102, and exit the axial heat sink at the second end 108. As described in detail below, in the example wherein the light bulb 100 is operated with the longitudinal axis 110 vertical and the base 140 down, cooling air can additionally enter the internal volume 112 of the axial heat sink 102 through the first end 106, flow through the internal volume 112 of the axial heat sink 102, and exit the axial heat sink at the through-slots 116 or the second end 108. With the base 140 up, the direction of air flow is reversed.

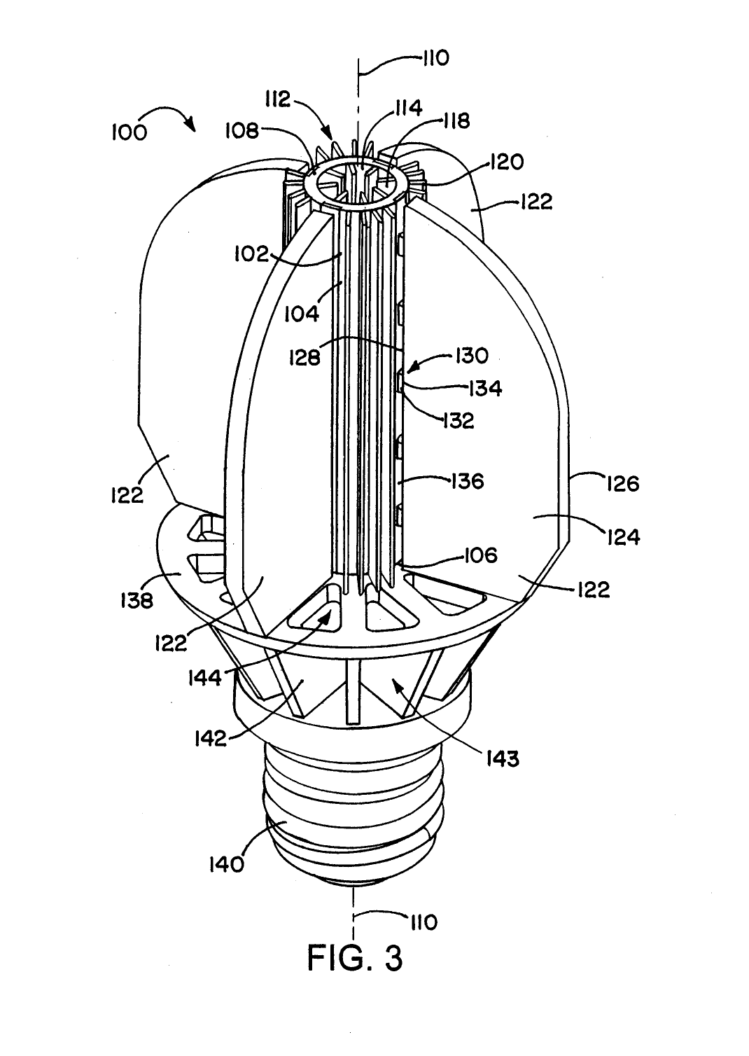

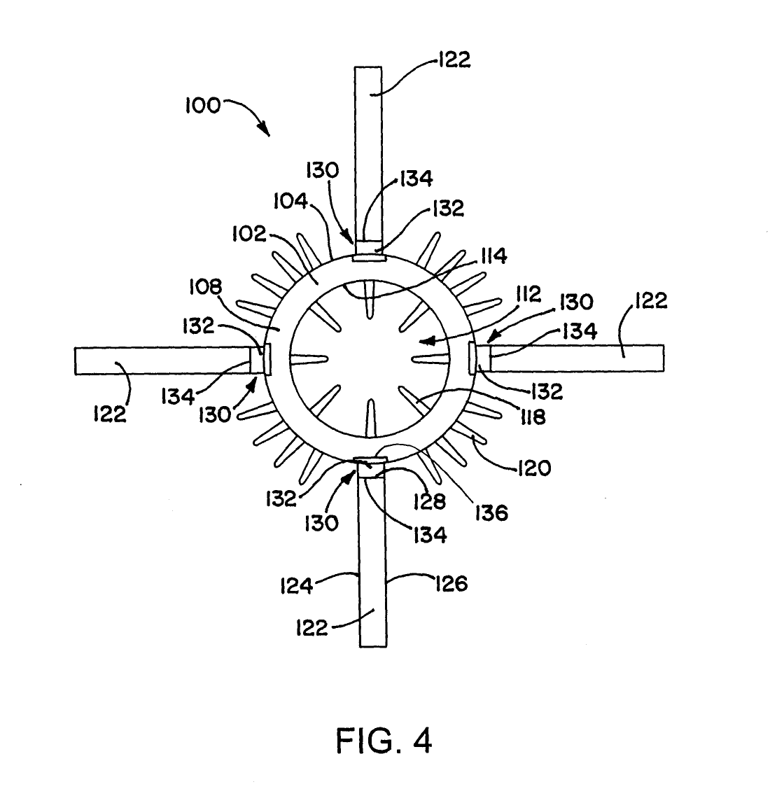

Other embodiments of the light bulb 100 include other thermal features, either alone or in combination with the axial through-slots 116, which improve the dissipation of heat generated by the light source 120. For example, FIGS. 3 and 4 show an embodiment of the light bulb 100 wherein the axial heat sink 102 includes interior axial fins 118 extending radially inward from the inner major surface 114 of the axial heat sink 102. The axial heat sink 102 additionally includes exterior axial fins 120 extending radially outward from the outer major surface 104 of the axial heat sink 102 and interleaved with the light guides 122. The interior axial fins 118 and the exterior axial fins 120 are thermally coupled to the light source 130 and provide an increased surface area available for cooling. The number and thickness of the interior axial fins 118 and the exterior axial fins 120 are chosen such that there is sufficient space between the fins to provide paths for the air flowing past the outer major surface 104 of the axial heat sink 102, and for the air entering one of the ends 106, 108 of the axial heat sink 102 and flowing through the internal volume 112 thereof.

With continuing reference to FIGS. 1 and 2, the light bulb 100 includes planar light guides 122 disposed about the axial heat sink 102. In the example shown in FIGS. 1 and 2, the light guides 122 are radially disposed about the axial heat sink 102. Examples having a non-radial arrangement will be described below. Each light guide 122 is a solid article made from, for example, acrylic, polycarbonate, poly(methyl-methacrylate) (PMMA), glass, or other appropriate material. The light guide 102 may also be a multi-layer light guide having two or more layers that may differ in refractive index. The light guides 122 are retained by the axial heat sink 102, one or more structural components (not shown) of the light source 130, and/or the housing 138.

Each light guide 122 includes a first major surface 124 and a second major surface 126 opposite the first major surface 124. The light guide 122 is configured to propagate light by total internal reflection between the first major surface 124 and the second major surface 126. The length and width dimensions of each of the major surfaces 124, 126 are greater, typically five or more times greater, than the thickness of the light guide 122. The thickness is the dimension of the light guide 122 in a direction orthogonal to the major surfaces 124, 126. The major surfaces 124, 126 of the light guide 122 may be slightly curved about at least one of an axis orthogonal to the longitudinal axis 110 and an axis parallel to the longitudinal axis 110. The term slightly curved is used herein to refer to a curved surface having an angle between tangents at opposite ends thereof of about 140° or more. Slightly curved light guides are described herein as planar.

The opposed major surfaces 124, 126 of each light guide 122 extend in a direction having a radial component with respect to the longitudinal axis 110. The opposed major surfaces 124, 126 also extend in a direction having an axial component. The embodiment of the light bulb 100 shown in FIGS. 1-4 includes four light guides 122 radially disposed about the axial heat sink 102 and extending radially outward from the longitudinal axis 110. The arrangement may be referred to as an “X-shaped” arrangement. In other embodiments, the light bulb 100 includes more or fewer light guides 122. For example, one embodiment of the light bulb 100 includes three light guides 122 radially disposed about the axial heat sink 102 and may be referred to as a “Y-shaped” arrangement. Furthermore, in other embodiments, the opposed major surfaces 124, 126 of at least one of the light guides 122 are angled and/or slightly curved relative to a radius extending from the longitudinal axis.

At least one edge extends between the major surfaces 124, 126 of the light guide 122 in the thickness direction, the total number of edges depending on the configuration of the light guide 122. Depending on the geometry of the light guide 122, each edge surface may be straight or curved, and adjacent edge surfaces may meet at a vertex or join in a curve. Moreover, each edge surface may include one or more straight portions connected to one or more curved portions.

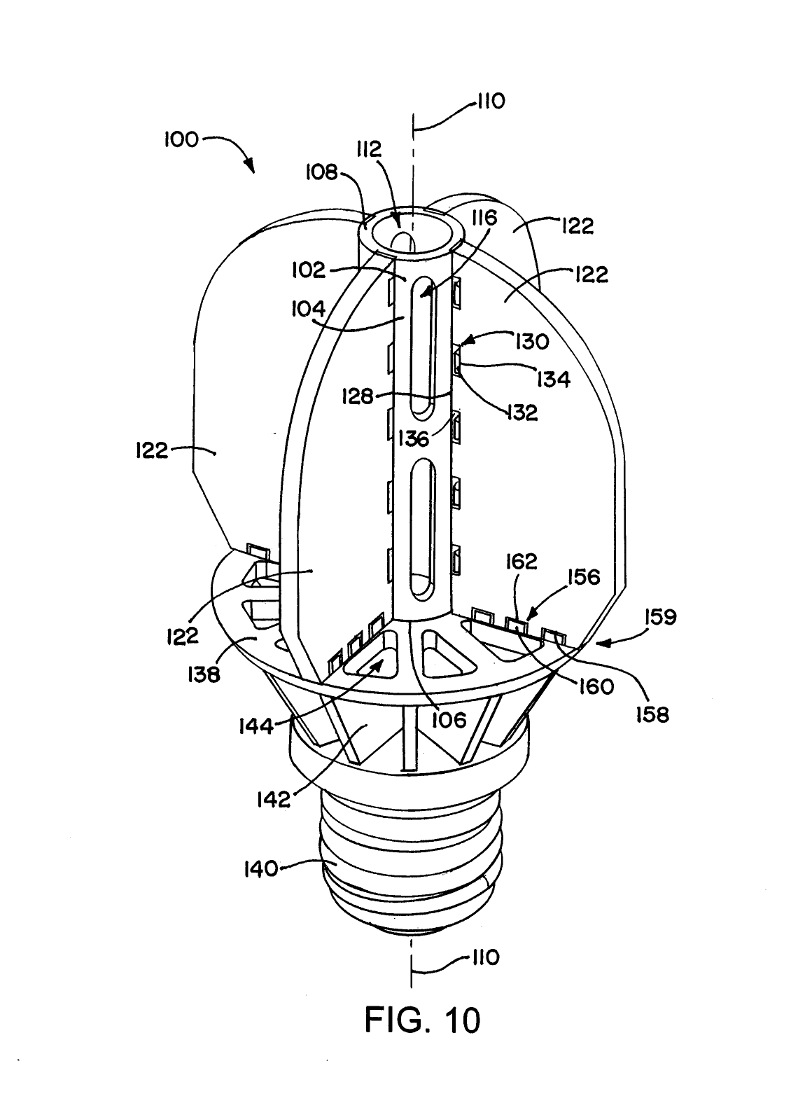

The edge surface through which light from the light source 130 is input to the light guide 122 will now be referred to as a light input edge 128. The light input edge 128 of each light guide 122 is adjacent the outer major surface 104 of the axial heat sink 102 and substantially conforms to the outer major surface 104 of the axial heat sink 102. In the example shown, the light input edge 128 is linear. In other embodiments, the light input edge 128 of the light guide 122 includes one or more recessed portions in which one or more solid-state light emitters 132 of the light source 130 is disposed (FIG. 10). In other embodiments, the light input edge 128 may curve about at least one of an axis orthogonal to the longitudinal axis 110 and an axis parallel to the longitudinal axis 110, and may substantially conform to the contour of the outer major surface 104 of the axial heat sink 102.

The light guide 122 includes light extracting elements 125 in, on, or beneath at least one of the major surfaces 124, 126. Light extracting elements 125 that are in, on, or beneath a major surface 124, 126 will be referred to as being “at” the major surface. Each light extracting element 125 functions to disrupt the total internal reflection of the propagating light that is incident on the light extracting element 125. In one embodiment, the light extracting elements reflect light toward the opposing major surface so that the light exits the light guide 122 through the opposing major surface. Alternatively, the light extracting elements transmit light through the light extracting elements and out of the major surface of the light guide 122 having the light extracting elements. In another embodiment, both types of light extracting elements are present. In yet another embodiment, the light extracting elements reflect some of the light and refract the remainder of the light incident thereon. Therefore, the light extracting elements are configured to extract light from the light guide 122 through one or both of the major surfaces 124, 126.

Exemplary light extracting elements 125 include light-scattering elements, which are typically features of indistinct shape or surface texture, such as printed features, ink jet printed features, selectively-deposited features, chemically etched features, laser etched features, and so forth. Other exemplary light extracting elements include features of well-defined shape, such as V-grooves, lenticular grooves, and features of well-defined shape that are small relative to the linear dimensions of the major surfaces 124, 126, which are referred to herein as micro-optical elements. The smaller of the length and width of a micro-optical element is less than one-tenth of the longer of the length and width of the light guide 122 and the larger of the length and width of the micro-optical element is less than one-half of the smaller of the length and width of the light guide. The length and width of the micro-optical element is measured in a plane parallel to the major surface 124, 126 of the light guide 122 for planar light guides or along a surface contour of the major surface 124, 126 for non-planar light guides 122.

Micro-optical elements are shaped to predictably reflect or refract light. However, one or more of the surfaces of the micro-optical elements may be modified, such as roughened, to produce a secondary effect on light output. Exemplary micro-optical elements are described in U.S. Pat. No. 6,752,505 and, for the sake of brevity, are not described in detail in this disclosure.

The light extracting elements 125 are configured to extract light in a defined intensity profile over one or both of the major surfaces 124, 126, such as a uniform intensity profile, and/or a defined light ray angle distribution. In this disclosure, intensity profile refers to the variation of intensity with position within a light-emitting region (such as the major surface 124, 126 or a light output region of the major surface 124, 126). Furthermore, the term light ray angle distribution is used to describe the variation of the intensity of light with ray angle (typically a solid angle) over a defined range of light ray angles. In an example in which the light is emitted from an edge-lit light guide, the light ray angles can range from −90° to +90° relative to the normal to the major surface 124, 126.

Light guides 122 having light extracting elements 125 are typically formed by a process such as molding. The light extracting elements are typically defined in a shim or insert used for molding light guides by a process such as diamond machining, laser etching, laser micromachining, chemical etching, or photolithography. Alternatively, any of the above-mentioned processes may be used to define the light extracting elements in a master that is used to make the shim or insert. Light guides without light extracting elements are typically formed by a process such as molding or extruding, and the light extracting elements 125 are subsequently formed on one or both of the major surfaces 124, 126 by a process such as stamping, embossing, or laser etching, or another suitable process. Light extracting elements may also be produced by depositing elements of curable material on the major surface 124, 126 of the light guide 122 and curing the deposited material using heat, UV-light, or other radiation. The curable material can be deposited by a process such as printing, ink jet printing, screen printing, or another suitable process. Alternatively, the light extracting elements 125 may be inside the light guide between the major surfaces 124, 126 (e.g., the light extracting elements 125 may be light redirecting particles and/or voids disposed in the light guide).

In some embodiments, one or more optical adjusters (not shown) are located adjacent one or both of the major surfaces 124, 126 of the light guide 122. Each optical adjuster has an optical modifying characteristic that modifies a property (e.g., spectrum, polarization, light ray angle distribution, and/or intensity) of the light extracted through the respective major surface 124, 126 of the light guide 122.

The light bulb 100 further includes light sources 130 mounted to the outer major surface 104 of the axial heat sink 102. For each light guide 122, a respective light source 130 is positioned adjacent the light input edge 128 to edge light the light guide 122 such that light from the light source propagates in the light guide 122 in a direction having a radial component with respect to the longitudinal axis 110 by total internal reflection at the opposed major surfaces 124, 126.

The light source 130 includes one or more solid-state light emitters 132. In one embodiment, the solid-state light emitters 132 constituting the light source 130 are arranged along the outer major surface 104 of the axial heat sink 102 parallel to longitudinal axis 110 or in another suitable pattern depending on the shape of the light input edge 128 of the light guide 122 to which the light source 130 supplies light. The solid-state light emitters 132 each respectively include a light output surface 134. The light source 130 is mounted to the axial heat sink 102 such that the light output surface 134 is nominally parallel to the outer major surface 104 of the axial heat sink 102.

Exemplary solid-state light emitters 132 include such devices as LEDs, laser diodes, and organic LEDs (OLEDs). In an embodiment where the solid-state light emitters 132 are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color. In one embodiment, the solid-state light emitters 132 emit light with no operably-effective intensity at wavelengths greater than 500 nanometers (nm) (i.e., the solid-state light emitters 132 emit light at wavelengths that are predominantly less than 500 nm). In some embodiments, the solid-state light emitters 132 constituting light source 130 all generate light having the same nominal spectrum. In other embodiments, at least one of the solid-state light emitters 132 constituting light source 130 generates light that differs in spectrum from the light generated by the remaining solid-state light emitters 132. For example, two different types of solid-state light emitter 132 are alternately located along the light source 130.

Although not specifically shown in detail, the light source 130 also includes structural components to retain the solid-state light emitters 132. In the example shown, the solid-state light emitters 132 are mounted to a printed circuit board (PCB) 136 that is mounted to the outer major surface 104 of the axial heat sink 102. In another embodiment, the PCB 136 is mounted in the axial heat sink 102 adjacent the inner major surface 114, and the axial heat sink 102 further includes one or more through-holes (not shown) in which the light emitters 132 of the light source 130 are disposed. In other embodiments, the light bulb 100 includes structural components (e.g., a mounting bracket) (not shown) to retain the light guide 122. The light source 130 may additionally include circuitry, power supply, electronics for controlling and driving the solid-state light emitters 132, and/or any other appropriate components.

The light bulb 100 further includes a housing 138 thermally coupled to the first end 106 of the axial heat sink 102. The housing 138 retains the axial heat sink 102, and in some embodiments, also retains the light guides 122. The housing 138 includes a base 140 configured to mechanically mount the light bulb 100 and receive electrical power. In the example shown, the base 140 is an Edison screw base. In other examples, the base 140 is a bayonet base, a bi-pin base, or any other suitable configuration to mechanically mount the light bulb and receive electrical power. FIGS. 1-4 show an embodiment wherein the base 140 is indirectly coupled to the axial heat sink 102 through the housing 138. Although not specifically shown, in other embodiments, the housing 138 has a simpler structure and/or is smaller than that shown.

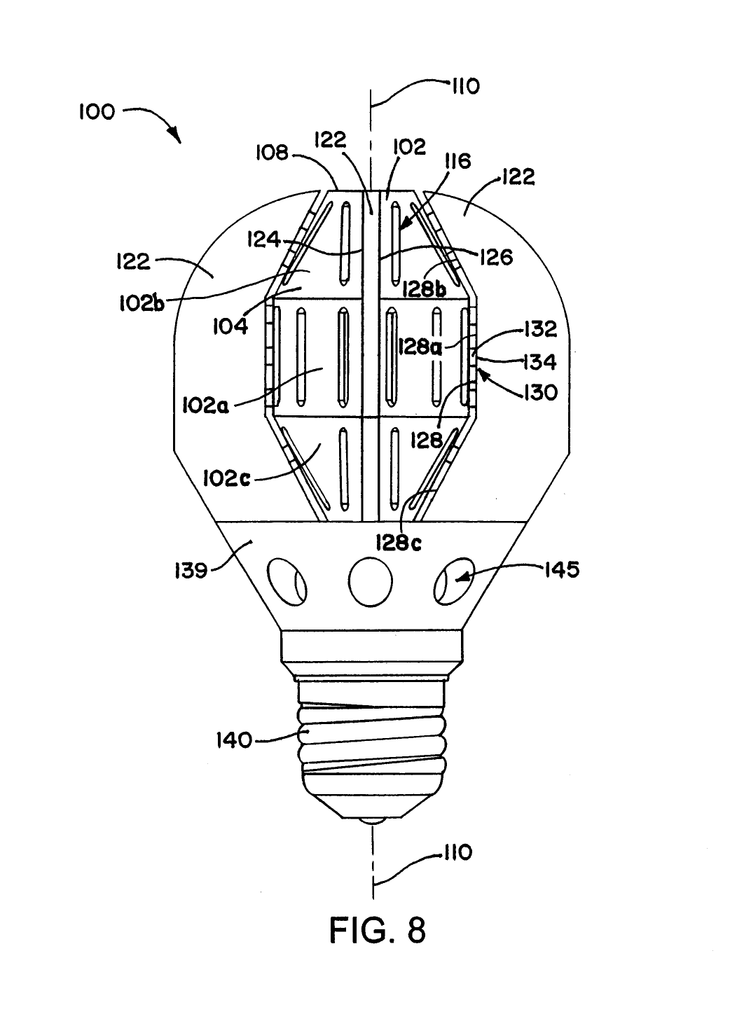

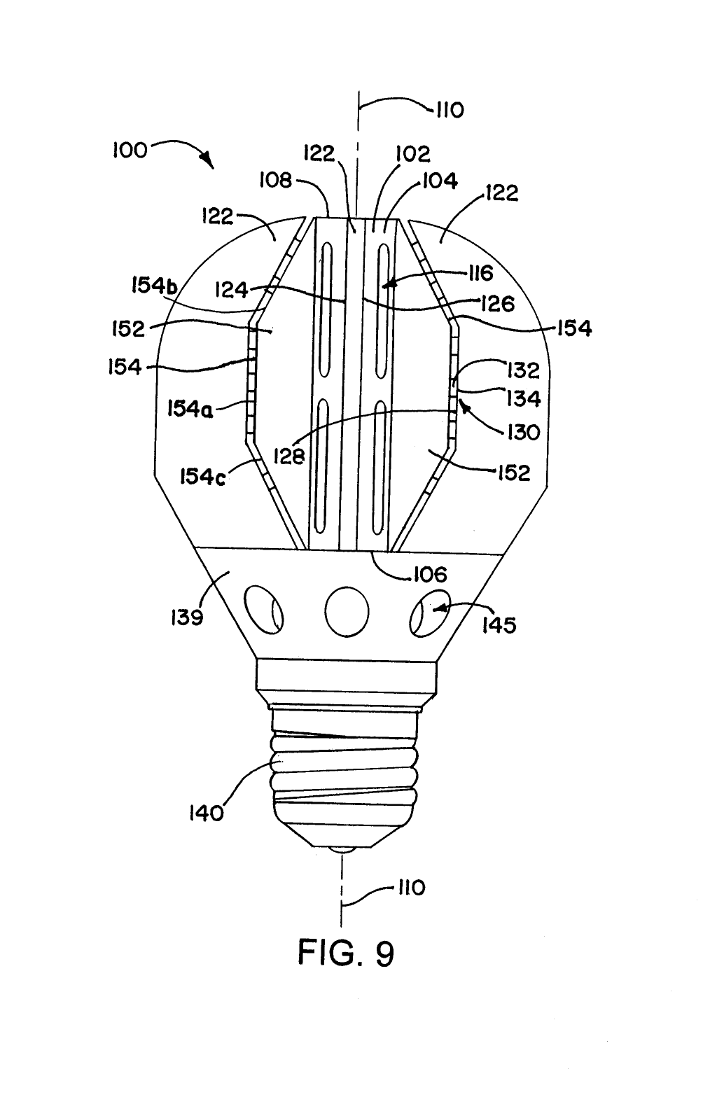

The housing 138 is thermally coupled to the light source 130 through the axial heat sink 102. In some embodiments, the housing 124 is shaped to provide an increased surface area available for cooling. In the example shown, the housing 138 includes axial buttresses 142 disposed parallel to the longitudinal axis 110 and extending radially from the longitudinal axis. Vents 143 bounded by adjacent axial buttresses 142 connect to vents 144 that extend axially through the housing 138. In other examples (FIGS. 8 and 9), the housing 138 includes a solid side surface 139 and vents 145 extending therethrough.

The vents 143 and 144 establish an airflow pathway through the housing 138 through which air flows by convection due to heating by the light source 130. When the light bulb 100 is operated with its longitudinal axis 106 vertical, cooling air enters the vents 143 between respective buttresses 142 and warm air exits through the vents 144. When the orientation of the light bulb 100 is inverted, the air flow is reversed.

In some embodiments, the vents 143 and/or 144 connect to the internal volume 112 of the axial heat sink 102 to provide a path for air flow and convection cooling into at least part of the internal volume 112. In such embodiments, when the light bulb 100 is operated with its longitudinal axis 106 vertical and the base 140 down, cooling air enters the area through the vents 143 between respective buttresses 142 and warm air exits the light bulb 100 through the open, second end 108 of the light guide 102. When the orientation of the light bulb 100 is inverted such that the base 140 is up, the air flow is reversed.

The light bulb 100 is configured to output light from the light bulb 100 having a light ray angle distribution similar to the light ray angle distribution of the light output from a conventional incandescent light bulb, CFL, or fluorescent tube. In the example shown in FIGS. 1-4, the light sources 130 are arranged such that light is emitted therefrom in a generally radial direction with respect to the longitudinal axis 110, and the light bulb 100 includes one or more features that achieve a suitable light ray angle distribution. In some embodiments, the light extracting elements 125 at the major surfaces 124, 126 are configured to direct the light extracted through the at least one of the opposed major surfaces 124, 126 in a direction having a similar axial component to the direction in which the light propagates in the light guide 122. In other embodiments, the light extracting elements 125 at the major surfaces 124, 126 are configured to direct the light extracted through the at least one of the opposed major surfaces 124, 126 in a direction having a greater axial component than the direction in which the light propagates in the light guide 122. In yet other embodiments, one or more optical adjusters adjacent the major surfaces 124, 126 of the light guide 122 are configured to redirect the light extracted through the at least one of the opposed major surfaces 124, 126 in a direction having a greater axial component than the direction in which the light is extracted from the light guide 122.

In some embodiments, a light redirecting element (not shown) at one or more of the edge surfaces of the light guide 122 is configured to redirect the light input to or output from the edge surface of the light guide 122. Exemplary redirecting elements include light-scattering elements and features of well-defined shape, such as V-grooves, lenticular grooves, and micro-optical elements. In one embodiment, the light redirecting element is an integral part of the edge surface. The light redirecting element may be formed concurrently with formation of the light guide 122 using a process such as molding or another suitable process; or by subjecting the edge surface of the light guide 122 to a process such as stamping, embossing, laser etching, chemical etching, or another suitable process. In another embodiment, the light redirecting element is a separate element from the light guide 122 that is optically coupled to the edge surface and retained by a resin, an adhesive, or one or more structural components.

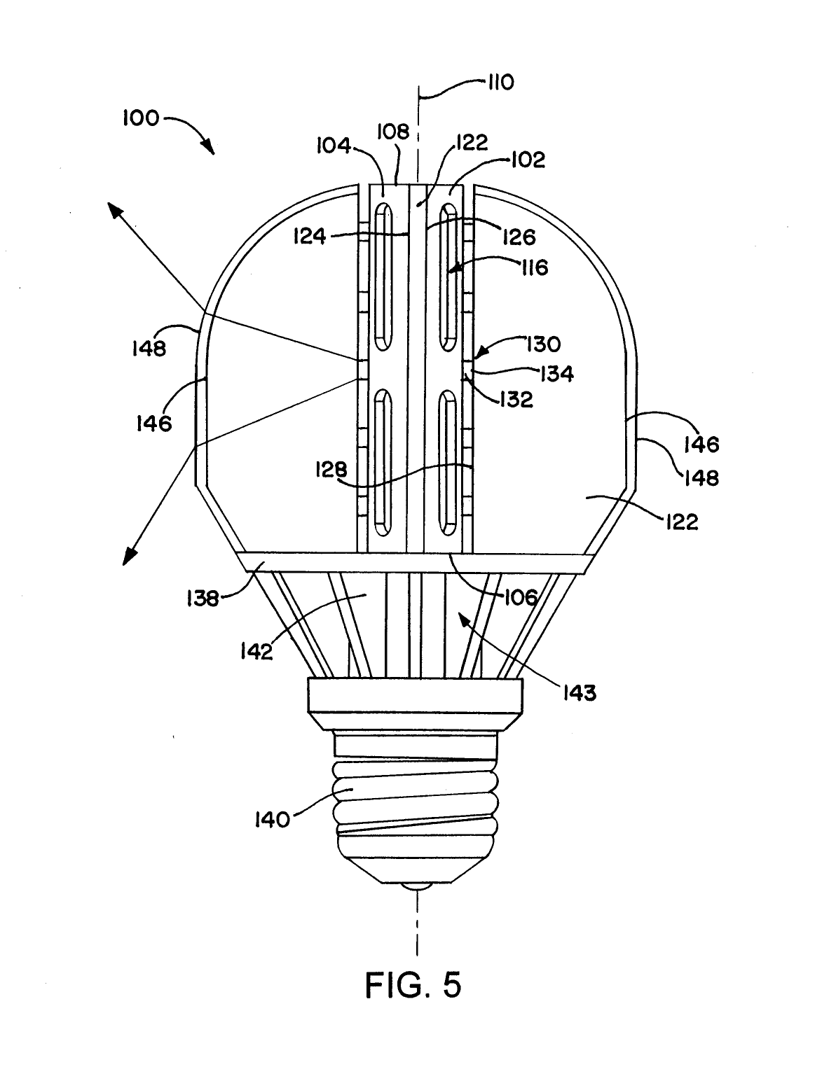

FIG. 5 shows an exemplary embodiment of the light bulb 100 where the edge surface 146 of the light guide 122 extending between the opposed major surfaces 124, 126 and opposite the light input edge 128 includes a light redirecting element 148 configured to modify the light ray angle distribution of the light output from the edge surface 146 of the light guide 100. As shown, the light emitted from the light source 130 and input to the light guide 122 propagates in the light guide 122, is output from the edge surface 146, and is incident the light redirecting element 148. In some embodiments, the light redirecting element 148 spreads the light output from the end edge 146 of the light guide 100 in a direction parallel to the longitudinal axis 110, thereby increasing the axial component of the light output from the edge 146 of the light guide 122. In other embodiments, the light redirecting element 148 spreads the light output from the end edge 146 of the light guide 100 in a direction orthogonal to the longitudinal axis 110 and to at least one of the major surfaces 124, 126 of the light guide.

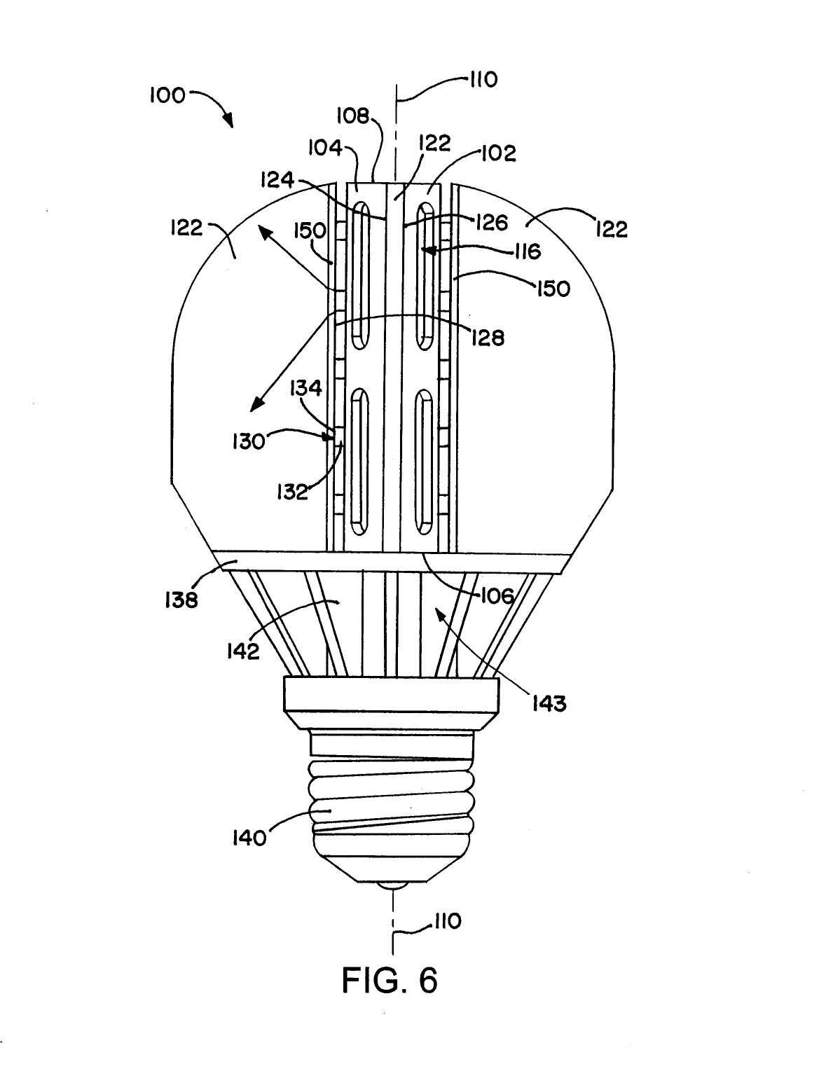

FIG. 6 shows an exemplary embodiment of the light bulb 100 where the light input edge 128 includes a light redirecting element 150 configured to modify a light ray angle distribution of the light input to the light guide 122 from the light source 130. As shown, light emitted from the light source 130 is incident on the light redirecting element 150. The light redirecting element 150 spreads the light input to the light input edge 128 of the light guide 122 in a direction parallel to the longitudinal axis 110, thereby increasing the axial component of the light input to the light guide 122.

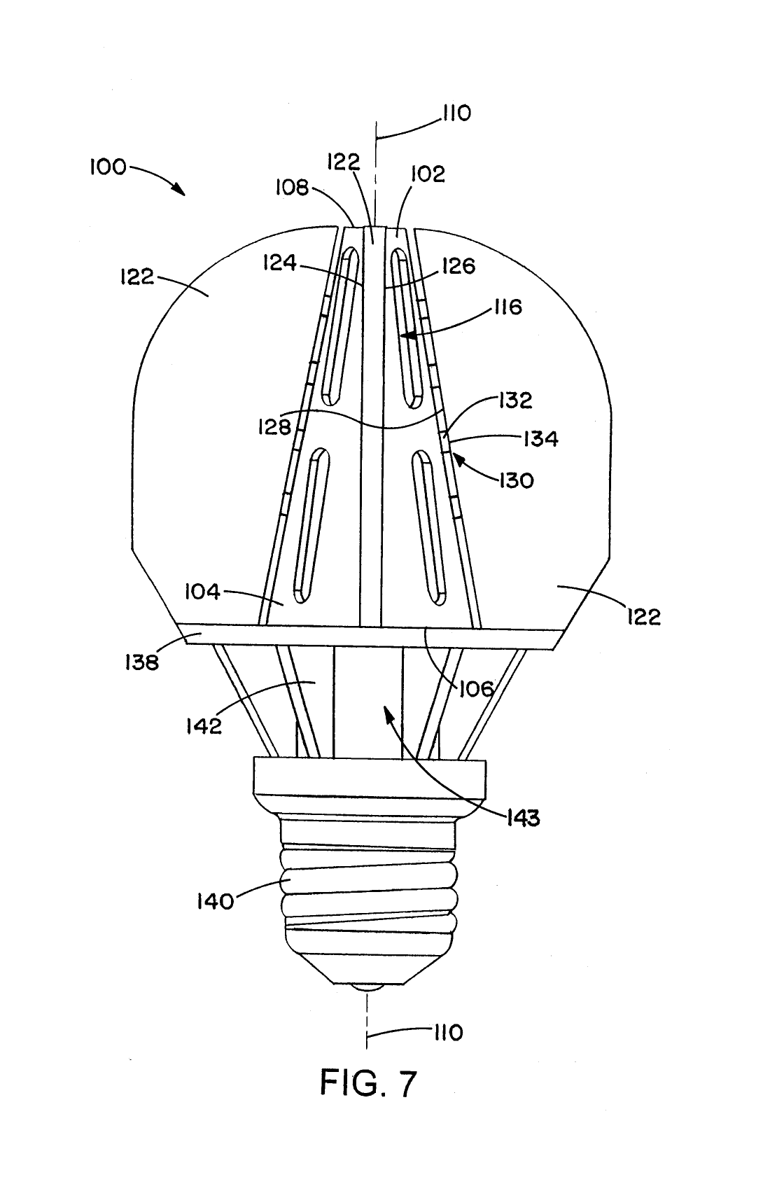

In other embodiments, the light source 130 and one or more portions of the axial heat sink 102 are arranged relative to the longitudinal axis 110 to attain a desired light ray angle distribution of the light output from the light bulb 100. FIG. 7 shows an exemplary embodiment of the light bulb 100 wherein the axial heat sink 102 is frustoconical in shape, and the light source 130 is mounted to the outer major surface 104 of the axial heat sink 102 such that the light output surface 134 of the solid-state light emitters 132 is non-parallel to the longitudinal axis 110. The light input edge 128 of each light guide 122 extends in a direction parallel to the light output surface 134 and is non-parallel to the longitudinal axis 110. The solid-state light emitters 132 emit light with a light ray angle distribution having a greater axial component than the light ray angle distribution emitted by a solid-state light emitter (such as the solid-state light emitters 132 shown in FIG. 1) having a light output surface 134 extending parallel to the longitudinal axis 110.

FIG. 8 shows an embodiment including an axial heat sink 102 that has a polygonal longitudinal cross-sectional shape that approximates a bulbous shape. A central portion 102a of the axial heat sink 102 extends in a direction parallel to the longitudinal axis 110, and outer portions 102b, 102c of the axial heat sink 102, bounding the central portion, respectively diverge from and converge toward the longitudinal axis 110 with increasing distance from the central portion 102a. The light input edge 128 of the light guide 122 is adjacent and substantially conforms to the outer major surface 104 of the axial heat sink 102 such that a central portion 128a of the light input edge 128 extends in a direction parallel to the longitudinal axis 110 and outer portions 128b, 128c of the light input edge 128 respectively diverge from the central portion 128a and converge toward the longitudinal axis 110 with increasing distance from the central portion 128a. The solid-state light emitters 132 respectively mounted on the outer portions 102b, 102c of the axial heat sink 102 emit light with a ray angle distribution having a greater axial component than the ray angle distribution emitted by the respective solid-state light emitters 132 mounted on the central portion 102a of the axial heat sink 102.

FIG. 9 shows an embodiment that includes an axial heat sink 102 having light source mounting fins 152 extending from the outer major surface 104. Mounted on each light source mounting fin 152 is a printed circuit board on which the solid-state light emitters 132 constituting light source 130 are mounted. A central portion 154a of the printed circuit board 154 extends in a direction parallel to the longitudinal axis 110, and outer portions 154b, 154c of the printed circuit board 154, bounding the central portion, diverge from the central portion 154a and converge on the longitudinal axis 110 with increasing distance from the central portion 154a. The light input edge 128 of each light guide 122 is adjacent and substantially conforms to the printed circuit board 154 of a respective light source mounting fin 152. The solid-state light emitters 132 respectively mounted on the portions of the outer portion 154b, 154c of the printed circuit board 154 emit light with a ray angle distribution having a greater axial component than the light ray angle distribution emitted by the respective solid-state light emitters 132 mounted on the central portion 154a of the printed circuit board 154.

In other embodiments, the light bulb 100 includes additional light sources 156 arrayed in a direction relative to the longitudinal axis to attain a desired light ray angle distribution of the light output from the light bulb 100. FIG. 10 shows an embodiment wherein, for each light guide 122, a second light source 156 is configured to input light to the light guide 122 in a direction having an axial component through a second light input edge 158. The second light input edge 158 is at an end 159 of the light guide 122 proximate the housing 138 and extending radially from the longitudinal axis 110. The second light source 156 is retained by the housing 138 and positioned adjacent the second light input edge 158. The second light source 156 includes one or more solid-state light emitters 160 and may additionally include one or more structural components (e.g., PCB, circuitry, power supply, electronics, and/or any other appropriate components) to mount, retain, control, and drive the solid-state light emitters 160. The solid-state light emitters 160 each respectively include a light output surface 162 that is nominally orthogonal to the longitudinal axis 110.

The features of the light bulb described herein are meant to broadly encompass light-producing devices that fit into and engage any of various fixtures used for mechanically mounting the light-producing device and for providing electrical power thereto. As such, embodiments of the light bulb 100 may conform to an outer envelope of any conventional light bulb and may be configured to output light from the light bulb 100 with a light ray angle distribution similar to the light ray angle distribution of any conventional incandescent light bulb, CFL, or fluorescent tube. Other embodiments of the light bulb 100 may conform to an outer envelope of any conventional light bulb and may be configured to output light from the light bulb 100 with a light ray angle distribution more suitable for a defined application than the light ray angle distribution of any conventional incandescent light bulb, CFL, or fluorescent tube.

FIG. 11 shows an exemplary embodiment of a light bulb 100 conforming to an outer envelope of a PAR lamp. In the example shown, the light sources 130 are mounted to a portion of the outer major surface 104 of the axial heat sink 102 proximate the first end 106. Each light guide 122 includes an edge surface 166 extending between the opposed major surfaces 124, 126 and opposite the light input edge 128. The edge surface 166 is a reflective surface angled non-parallel to the longitudinal axis 110 to reflect the light input to the light guide 122 from the light source 130 that is incident thereon. The term reflective surface is used herein to refer to a surface having a reflectivity greater than the inherent Fresnel reflectivity of the surface. In some embodiments, the reflective surface includes a reflective material or coating. The edge surface 166 extends in a direction non-parallel to the longitudinal axis 110 and is configured to reflect a portion of the light input to the light guide 122 from the light source 130 in a direction having a greater axial component than a direction in which the light is input to the light guide 122. As shown, the light input to the light guide 122 and incident the reflective edge surface 166 is reflected in a direction more parallel to the longitudinal axis 110 than the direction in which the light was input to the light guide 122. Light extracting elements 125 at the major surface 124, 126 are configured to extract the reflected light from the light guide 122.

The light bulb 100 additionally includes a reflector 168 extending from the housing and disposed around the light guides. The major surface 170 of the reflector 168 facing the light guides 122 is a reflective surface. Light extracted from the major surfaces 124, 126 of the light guide 122 and incident the major surface 170 of the reflector 168 is redirected by the major surface 170 in a direction more parallel to the longitudinal axis 110 than a direction in which the light was extracted from the light guide 122.

FIG. 12 shows an exemplary embodiment of a light bulb 100 conforming to the outer envelope of a fluorescent tube light (e.g., a T8, T10, or T12 fluorescent tube light). The light bulb 100 includes a respective housing 138, 1138 and base 140, 1140 at the first and the second ends 106, 108 of the axial heat sink 102. Each of the housings 138, 1138 is thermally coupled to the axial heat sink 102 at the respective first and second ends 106, 108 of the axial heat sink 102. In some embodiments, the respective first and second housings 138, 1138 also retain the light guides 122. Each housing 138, 1138 includes a bi-pin base 140, 1140 configured to mechanically mount the light bulb 100 and receive electrical power. Some of the solid-state light emitters 132 arranged along the axial heat sink 102 are electrically coupled to base 140, and the other solid-state light emitters 132 are electrically coupled to base 1140.

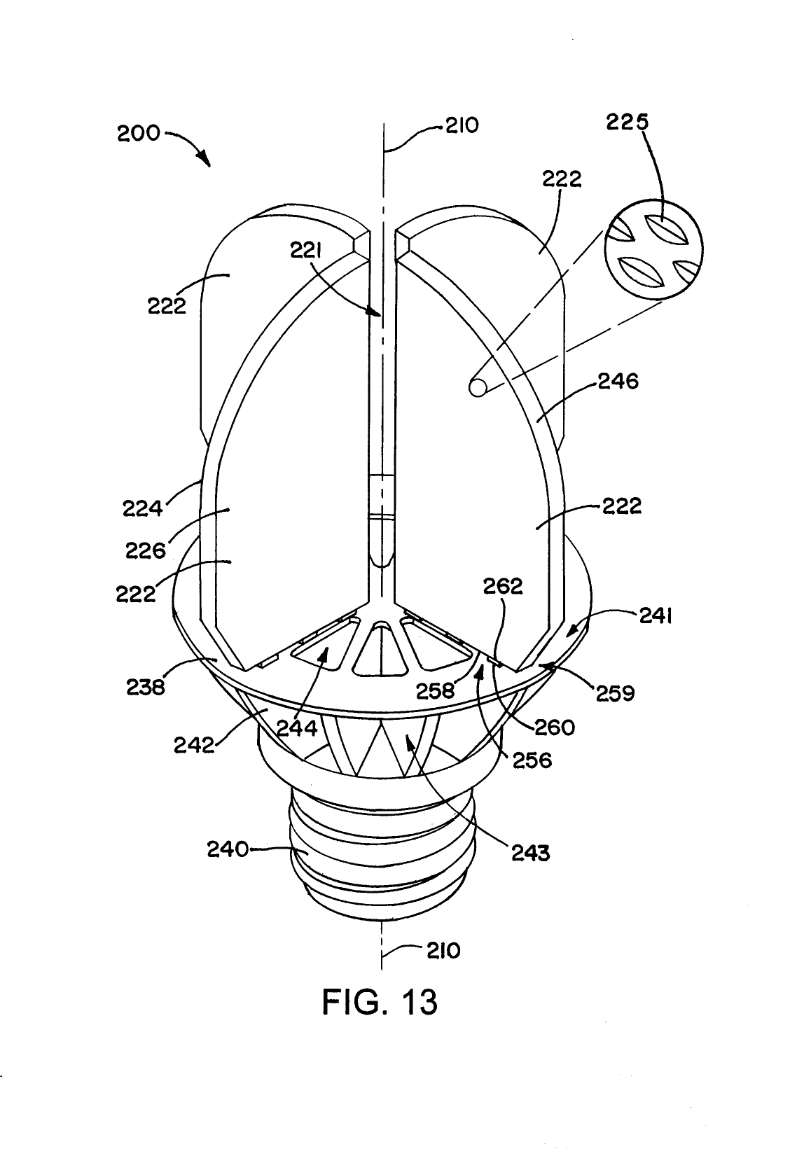

Referring now to FIGS. 13-15, another exemplary embodiment of the light bulb is shown at 200. The light bulb 200 is similar to the above-referenced light bulb 100 but lacks the axial heat sink 102 and has a light source 256 mounted on the housing 238 instead of the light source 130 mounted on the axial heat sink 102. The same reference numerals, but increased by 100, are used to denote features corresponding to similar features in the light bulb 200. In addition, the above description of the corresponding features is equally applicable to the light bulb 200 except as noted below.

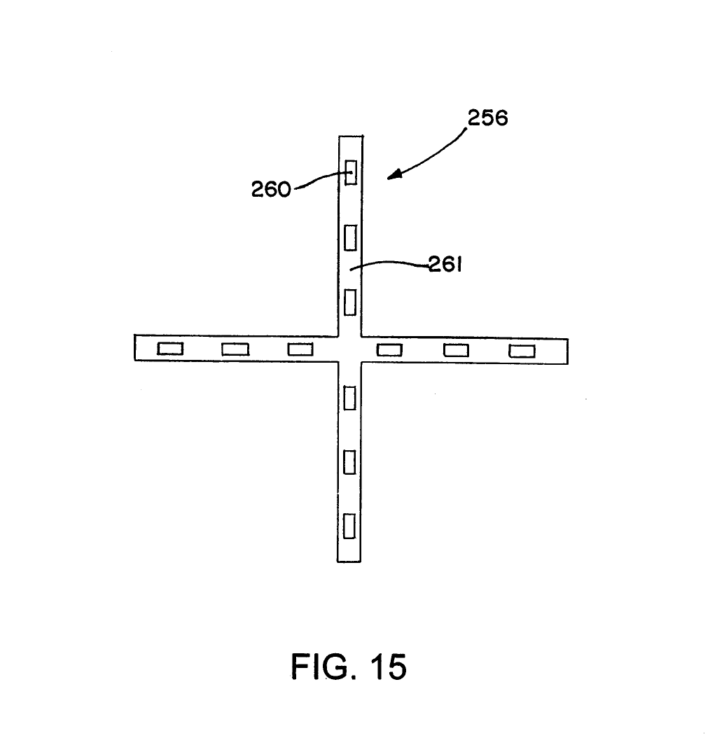

The light bulb 200 includes a housing 238 and a base 240 coupled to the housing, the base 240 configured to mechanically mount the light bulb 200 and receive electrical power. The housing 238 has a mounting surface 241. A longitudinal axis 210 extends normally from the center of the mounting surface 241 of the housing 238. The light source 256, including the solid-state light emitters 260 and printed circuit board 261 (FIG. 15), are mounted on the mounting surface 241. Any additional components not specifically shown (e.g., a light source driver) of the light source 256 are typically located within the housing 238. The solid-state light emitters 260 each respectively include a light output surface 262 arranged nominally orthogonal to the longitudinal axis 210.

The light source 256 is thermally coupled to the housing 238. The housing 238 includes axial buttresses 242 disposed parallel to the longitudinal axis 210 and vents 243 bounded by the adjacent axial buttresses 242. The vents 243 connect to vents 244 that extend axially through the housing 238. The vents 244 are circumferentially interleaved with the light sources 256. The vents 243 and 244 establish an airflow pathway through the housing 238 through which cooling air flows by convection due to heating by the light source 256.

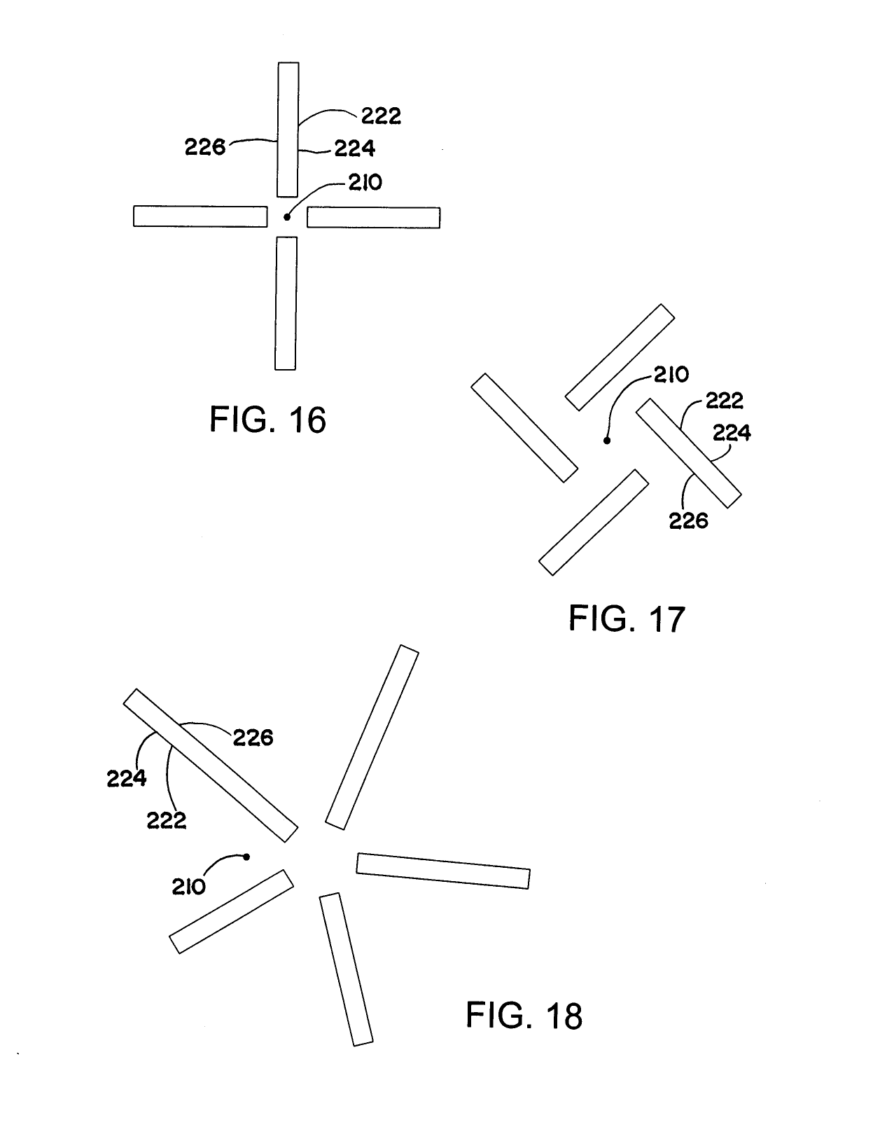

The light guides 222 are coupled to the housing 222. The opposed major surfaces 224, 226 of the light guides 222 extend in a direction having a radial component with respect to the longitudinal axis 210. The opposed major surfaces 224, 226 also extend in a direction having an axial component. FIG. 16 shows the embodiment of FIG. 13 where the opposed major surfaces 224, 226 of the light guides 222 extend radially outward from the longitudinal axis 210. In other embodiments, the opposed major surfaces 224, 226 of at least one of the light guides 222 are angled relative to a radius extending from the longitudinal axis. In the exemplary embodiment shown in FIG. 17, the opposed major surfaces 224, 226 of the respective light guides are arranged in mutually diverse planes (mutually orthogonal planes in the example shown) that do not extend through the longitudinal axis. In the exemplary embodiment shown in FIG. 18, the opposed major surfaces 224, 226 of the respective light guides are arranged such that they extend radially outward from an axis parallel to the longitudinal axis.

Referring again to FIG. 13, each light guide 222 includes opposed major surfaces 224, 226 and a light input edge 258 extending between the major surfaces 224, 226. The light input edge 258 is at an end 259 of the light guide 222 proximate the housing 238 and extends orthogonally to the longitudinal axis 210. For each light guide, a respective light source 256 is mounted to the housing 238 and is adjacent the light input edge 258 of the light guide 222 to input light to the light guide 222 through the light input edge 258 in a direction having an axial component. For example, FIG. 15 illustrates an “X-shaped” light source 256 arrangement that corresponds to the “X-shaped” arrangement of the light guides 222. Light emitted from the light source 256 and input to the light guide 222 propagates in the light guide 222 by total internal reflection at the opposed major surfaces 224, 226.

Each light guide 222 includes light extracting elements 225 at least one of the major surfaces 224, 226 to extract light from the light guide 222 through at least one of the major surfaces 224, 226. In some embodiments, the light extracting elements 225 are configured to direct the light through the at least one of the opposed major surfaces 224, 226. The light is extracted in a direction having a similar radial component to the direction in which the light propagates in the light guide 222. In other embodiments, the light extracting elements 225 are configured to redirect the light extracted through the at least one of the opposed major surfaces 224, 226 in a direction having a radial component greater than the direction in which the light propagates in the light guide 222. In yet other embodiments, one or more optical adjusters (not shown) are adjacent at least one of the major surfaces 224, 226 of the light guide 222 to modify the light ray angle distribution of the light extracted through the adjacent major surface. The one or more optical adjusters are configured to redirect the light extracted through the at least one of the opposed major surfaces in a direction having a radial component greater than the direction in which the light propagates in the light guide 222.

Although not specifically shown, in some embodiments, one or more of the edge surfaces or the light input edge 258 of the light guide 222 includes a light redirecting element configured to modify a light ray angle distribution of the light input to or output from the light guide 222.

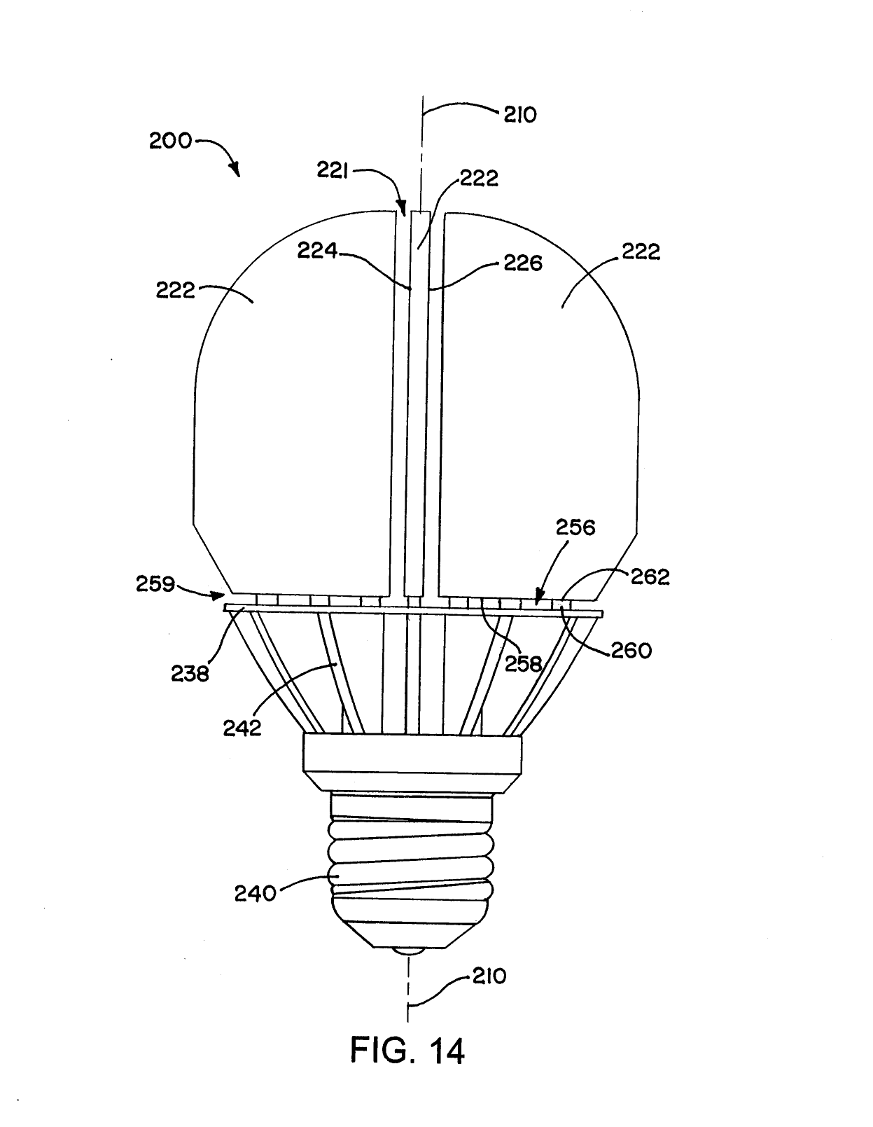

The exemplary embodiment shown in FIGS. 13 and 14 includes separate light guides 222 extending radially outward from the longitudinal axis 210. Gaps 221 between the light guides proximate the longitudinal axis 210 allow air to flow therethrough, and in some embodiments, improve the dissipation of heat generated by the light source 256 by improving the flow of cooling air around the housing 238 (e.g., when the light bulb 200 is operated with the longitudinal axis 210 horizontal).

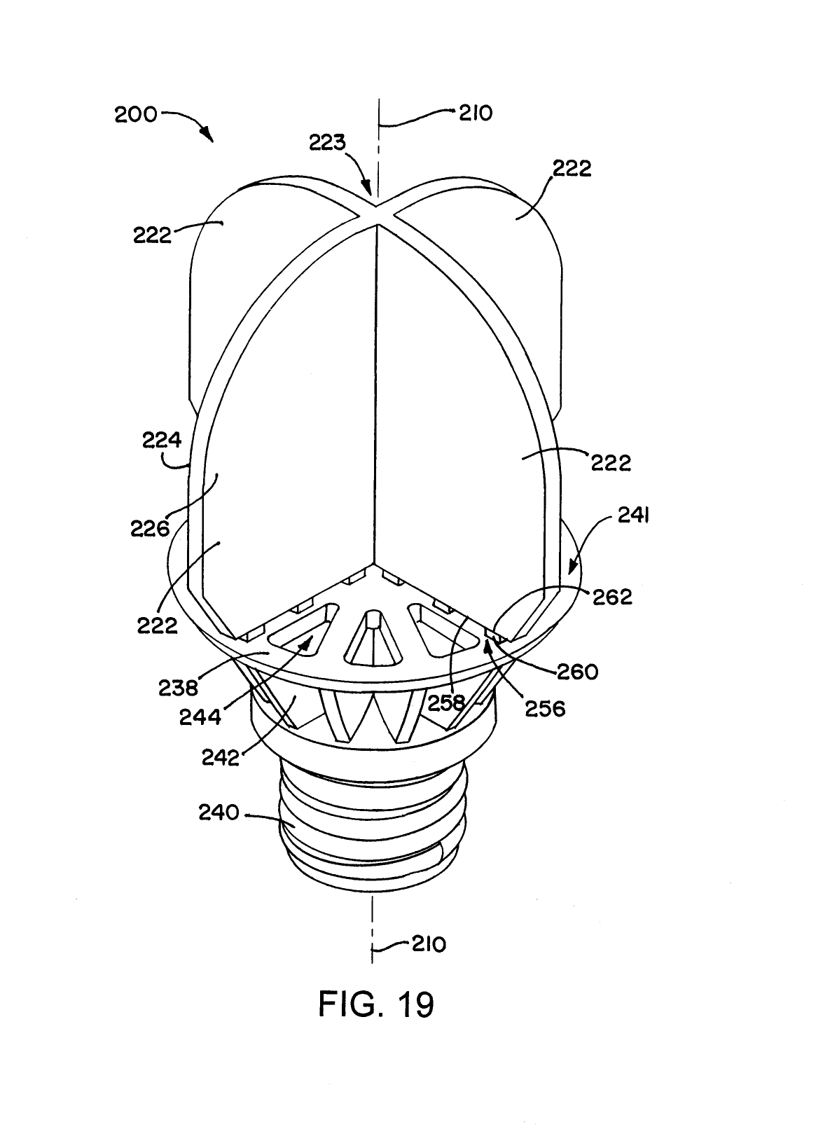

FIG. 19 shows an additional exemplary embodiment wherein the light guides are joined at and extend radially from a common node 223. In such an embodiment, the light guides 222 collectively form a branched light guide. The joining of the light guides 222 at the common node 223 allows for light input to the branched light guide to propagate in more than one of the light guide branches by total internal reflection. FIG. 19 also shows an embodiment where the common node is located on the longitudinal axis. In other embodiments (not shown), the common node 223 is offset from the longitudinal axis.

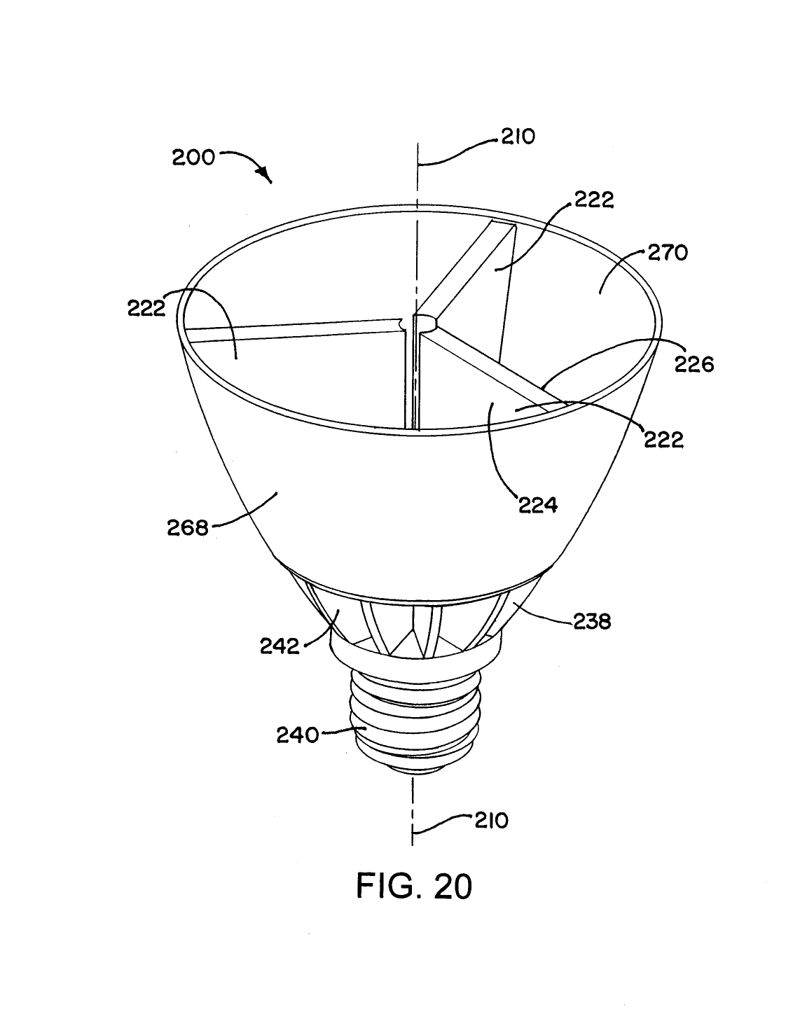

As described above, the features of the light bulb 200 described herein are meant to broadly encompass light-producing devices that fit into and engage any of various fixtures used for mechanically mounting the light-producing device and for providing electrical power thereto. For example, FIG. 20 shows an embodiment of the light bulb 200 conforming to the outer envelope of a PAR lamp. In the example shown, the light bulb includes a reflector 268 extending from the housing 238 and disposed around the light guides 222. The major surface 270 of the reflector 268 facing the light guides 222 is a reflective surface. Light extracted from the light guide 222 and incident the major surface 270 of the reflector 268 is redirected in a direction more parallel to the longitudinal axis 210 than the direction in which the light was extracted from the light guide 222.

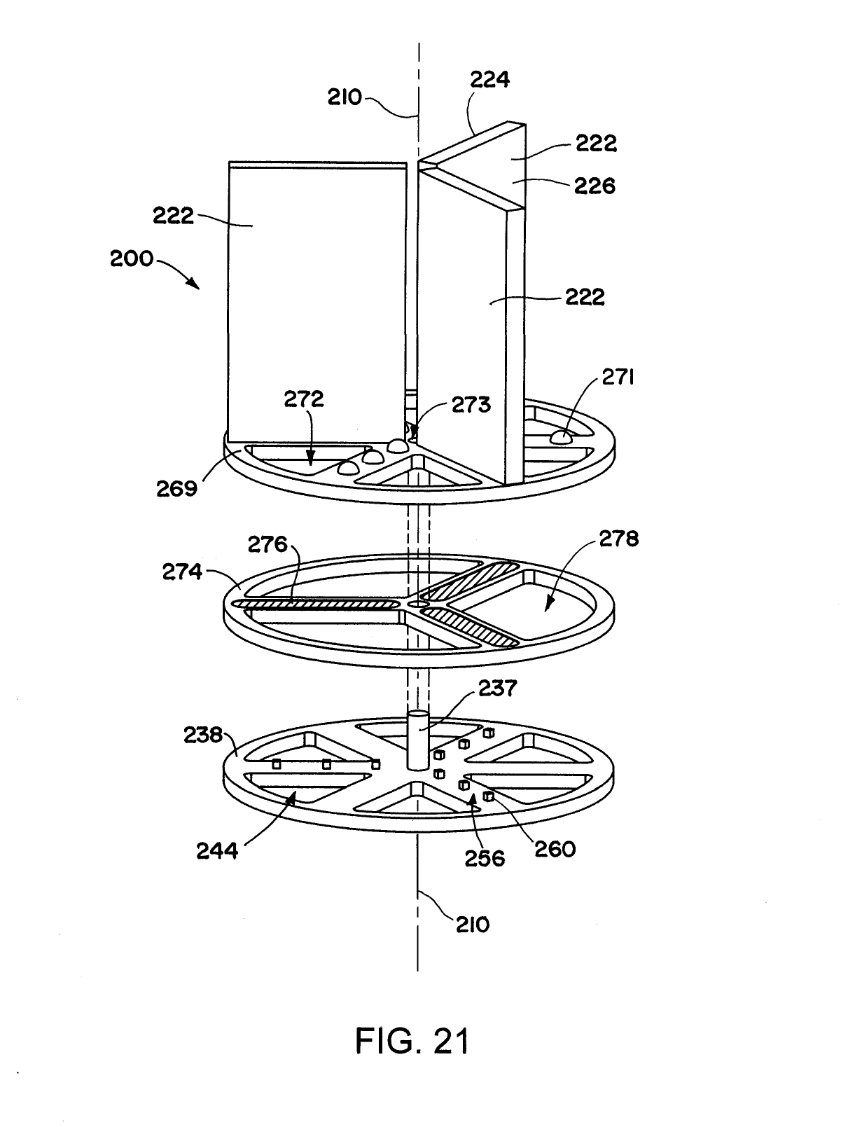

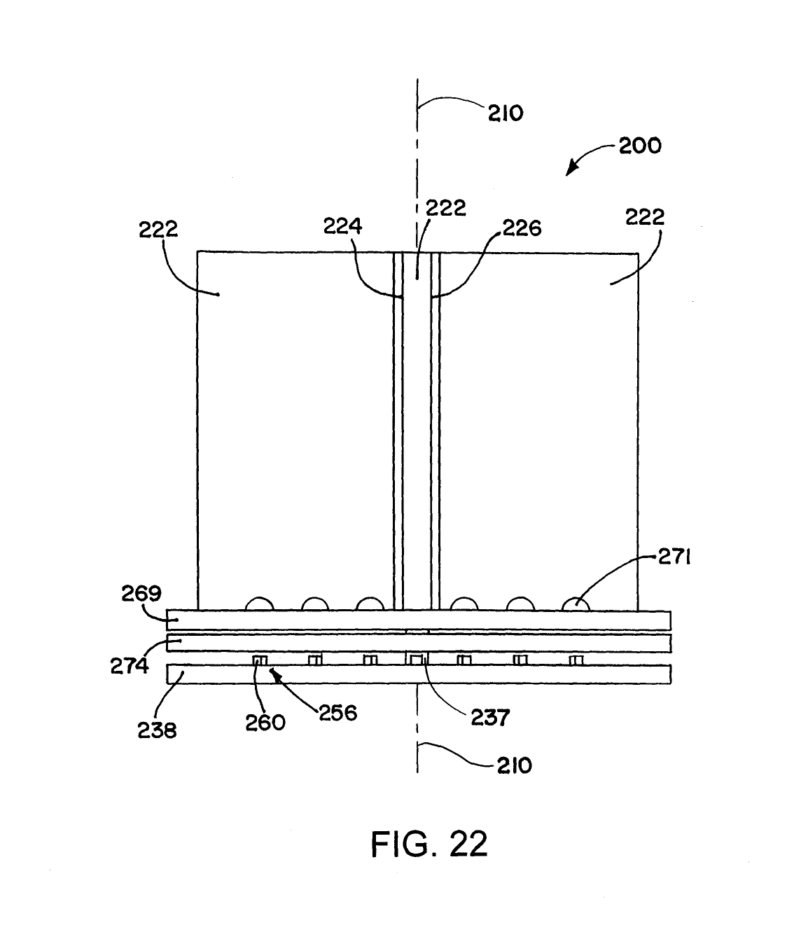

In some embodiments, the light bulb 200 is configured such that one or more of the light ray angle distribution and the spectrum of the light output from the light bulb 200 is adjustable. FIGS. 21 and 22 show an exemplary embodiment of a light bulb 200 in which the light guides 222 are rotatable relative to the light sources 258 about the longitudinal axis 210. Each light guide 222 is mounted to the rotatable member 269, and the rotatable member 269 is rotatably attached to the housing 238 to facilitate rotation of the light guides 222. In the illustrated example, the housing 238 includes an axle 237 that passes through a hub 273 of the rotatable member 269. The rotatable member 269 additionally includes lens elements 271 in a radially-extending arrangement. Each lens element 271 has a focusing characteristic that modifies the light ray angle distribution of the light incident thereon. The rotatable member 269 further includes vents 272 having no optical modifying characteristic. The light guides 222 are circumferentially interleaved with the lens elements 271 and with the vents 272.

The rotatable member 269 is rotatably attached to the housing 238 (via the axle 237) so as to rotate between a first state and a second state. In the first state, the rotatable member 269 is positioned such that the light input edge 258 of a respective light guide 222 is adjacent each light source 256 for the light source to edge light the light guide 222. In the second state, a respective lens element 271 is adjacent each light source 256 and light emitted from each light source 256 is focused by a respective lens element 271.

FIGS. 21 and 22 additionally show an optional rotatable spectrum adjuster 274 interposed between the housing 238 and the rotatable member 269. The rotatable spectrum adjuster 274 includes segments 276 having a spectrum adjusting characteristic interleaved with vents 278 having no spectrum adjusting characteristic. In one embodiment, the segments 276 having a spectrum adjusting characteristic include at least one of a wavelength shifter and a color attenuator. In a first state, the rotatable spectrum adjuster 274 is positioned such that each segment 276 having a spectrum adjusting characteristic is adjacent a respective light source 256. Accordingly, in the first state, the light emitted from the light source 256 passes through the rotatable spectrum adjuster positioned such that the light is spectrally adjusted. In a second state, the rotatable spectrum adjuster 274 is positioned such that each vent 278 is adjacent a respective light source 256. Accordingly, in the second state, the light emitted from the light source 256 passes through the rotatable spectrum adjuster 274 positioned such that the light is not spectrally adjusted.

The rotatable member 269 and the rotatable spectrum adjuster 274 are independently rotatable with respect to one another. Independent adjustment of the rotatable member 268 and the rotatable spectrum adjuster 274 allow for the light emitted from the light sources 256 to be output with a desired combination of properties (e.g., spectrum and/or light ray angle distribution). In addition, the vents 272, 278 provide air flow regardless of the relative rotational positions of the housing 238, the rotatable spectrum adjuster 274 and the rotatable member 269.

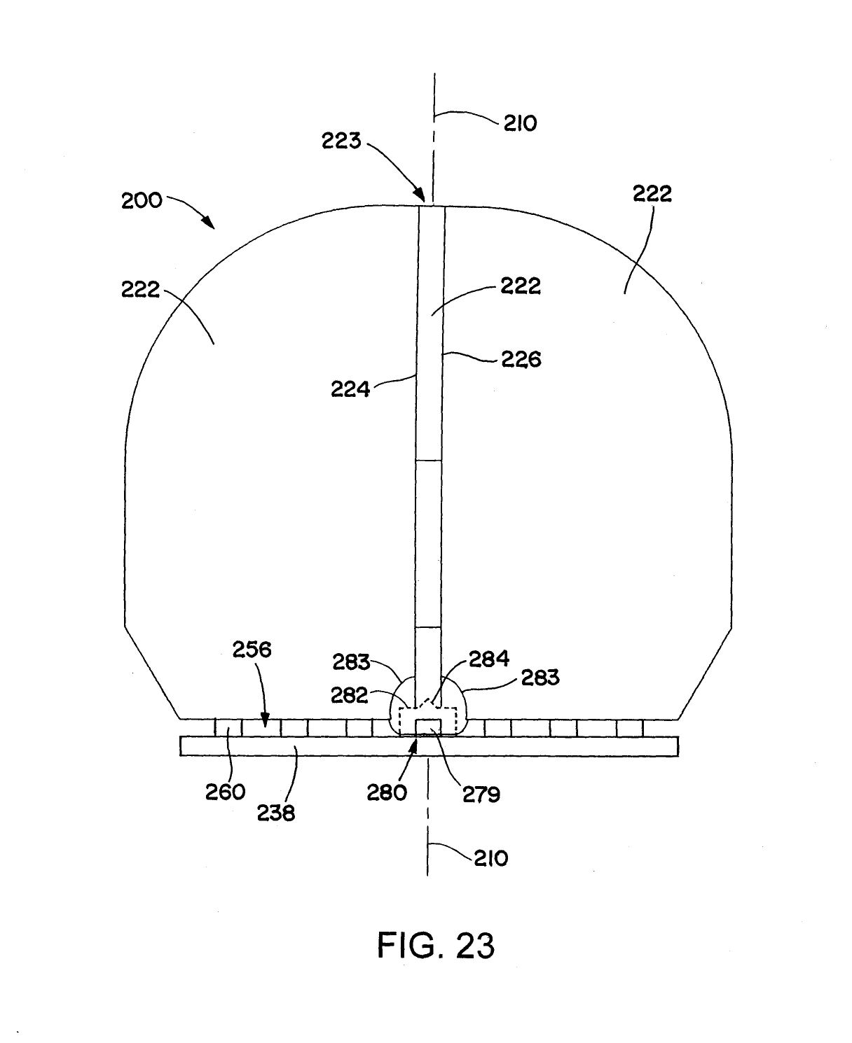

Referring now to FIG. 23, in some embodiments, the light bulb 200 additionally includes a second light source 280. Light output from the first light source 256 and light output from the second light source 280 collectively provides the light output from the light bulb 200. The light output from this example of the light bulb 200 has a light ray angle distribution different from the light ray angle distribution that would be obtained with the light guides illuminated by light source 256 or light source 280 individually. In some embodiments, the first light source 256 and the second light source 280 emit light of the same or similar spectrum. In other embodiments, the first light source 256 emits light of a first spectrum, and the second light source 280 emits light of a second spectrum, different from the first spectrum. The light of the second spectrum mixes with the light of the first spectrum so that output light output from the light bulb 200 has a spectrum that is a combination of the first spectrum and the second spectrum. In an example, the light of the first spectrum has a cool white spectrum, the light of the second spectrum has red, orange or amber spectrum, and the output light has a spectrum that is warmer than the first spectrum.

In some embodiments, the second light source 280 is adjacent an optical element 282 that is configured to redirect light emitted from the second light source 280 in a radial direction, and at least a portion of the redirected light is input to the respective light guides 222. FIG. 23 shows the embodiment of the light bulb 200 having the light guides 222 extending radially from a common node 223 (FIG. 19). The light bulb 200 additionally includes the second light source 280 and the optical element 282. Each light guide 222 includes a notch 283 at the common node along the longitudinal axis 210 proximate the housing 238. The notches 283 collectively form a void in which the optical element 282 is disposed. The optical element 282 includes a pyramidal element 284 that is configured to direct at least a portion of the light input from the second light source 280 toward each light guide 222. In other embodiments, the optical element 282 includes one or more of micro-optical elements, optical elements of well-defined shape, and light-scattering elements. The second light source 280 includes one or more solid-state light emitters 279 mounted to the housing 238 and adjacent the optical element 282. A portion of the light emitted by the second light source 280 and output from the optical element 282 is incident the notch 283 of each light guide 222 and edge lights the light guide 222 through the notch 283. Another portion (typically the remainder) of the light emitted by the second light source 280 and output from the optical element 282 is emitted from the light bulb 200 without edge lighting the light guide 222.

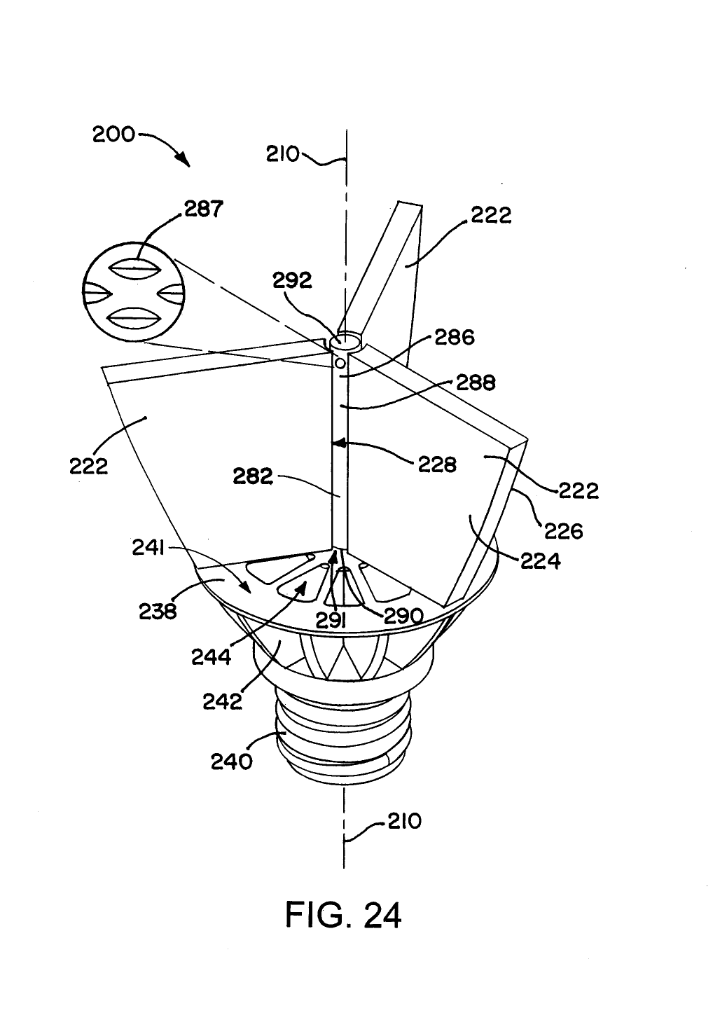

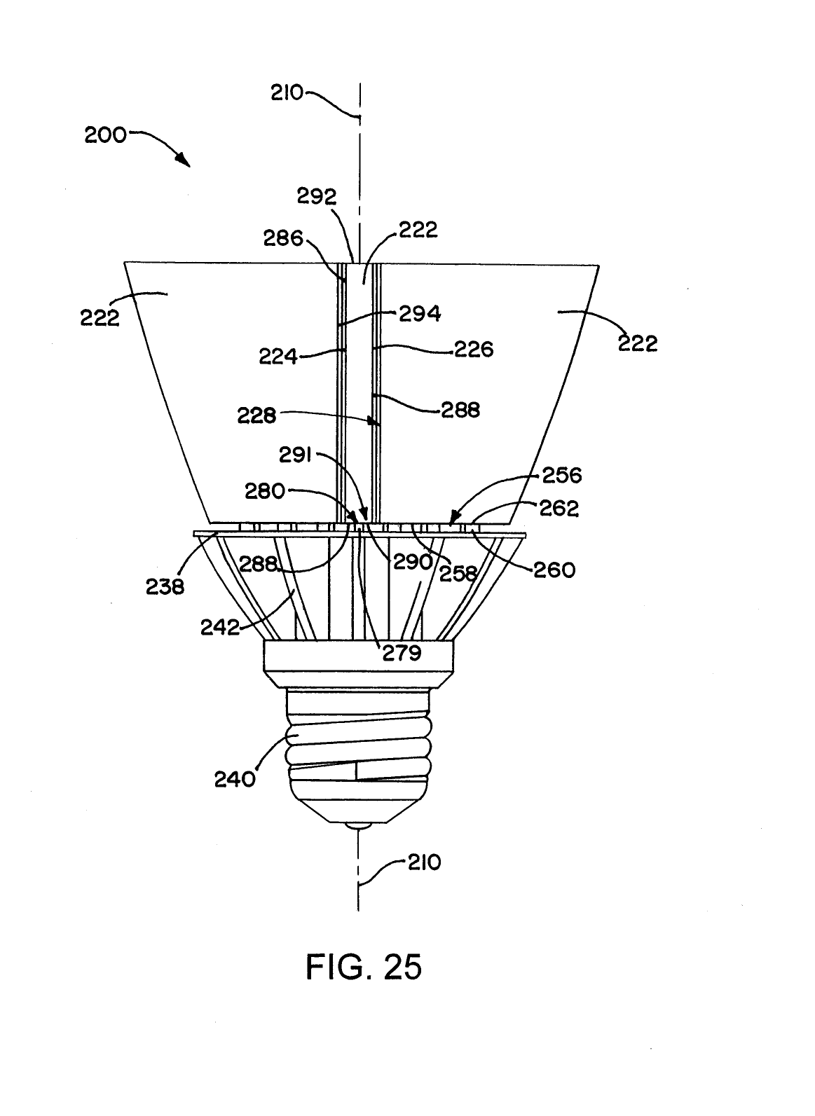

FIGS. 24 and 25 show the embodiment of the light bulb 200 having separate radially extending light guides 222 (FIGS. 13, 14, and 20). The light bulb 200 additionally includes the second light source 280 and the optical element 282 embodied as an auxiliary light guide 286 end lit by the second light source 280. The auxiliary light guide 286 is a solid article having an outer major surface 288. The auxiliary light guide 286 extends between a proximal end 290 and a distal end 292 along the longitudinal axis 210. The proximal end 290 of the auxiliary light guide 286 provides a light input surface 291 through which light from the second light source 280 end lights the auxiliary light guide 286. Light extracting elements 287 at the outer major surface 288 extract light from the auxiliary light guide. Each light guide 222 includes a second light input edge 228 adjacent the outer major surface 288 of the auxiliary light guide 286 and extending in a direction parallel to the longitudinal axis 210. Light extracted from the auxiliary light guide 286 is incident on the second light input edge 228 of each light guide 222 and edge lights the light guide 222. In some embodiments, light extracting elements 287 are located in areas circumferentially aligned with the light guides 222. In other embodiments, the light extracting elements 287 are located at the entire surface of the auxiliary light guide 286, and a portion of the light extracted from the auxiliary light guide 286 is emitted from the light bulb 200 without edge lighting the light guides 222.

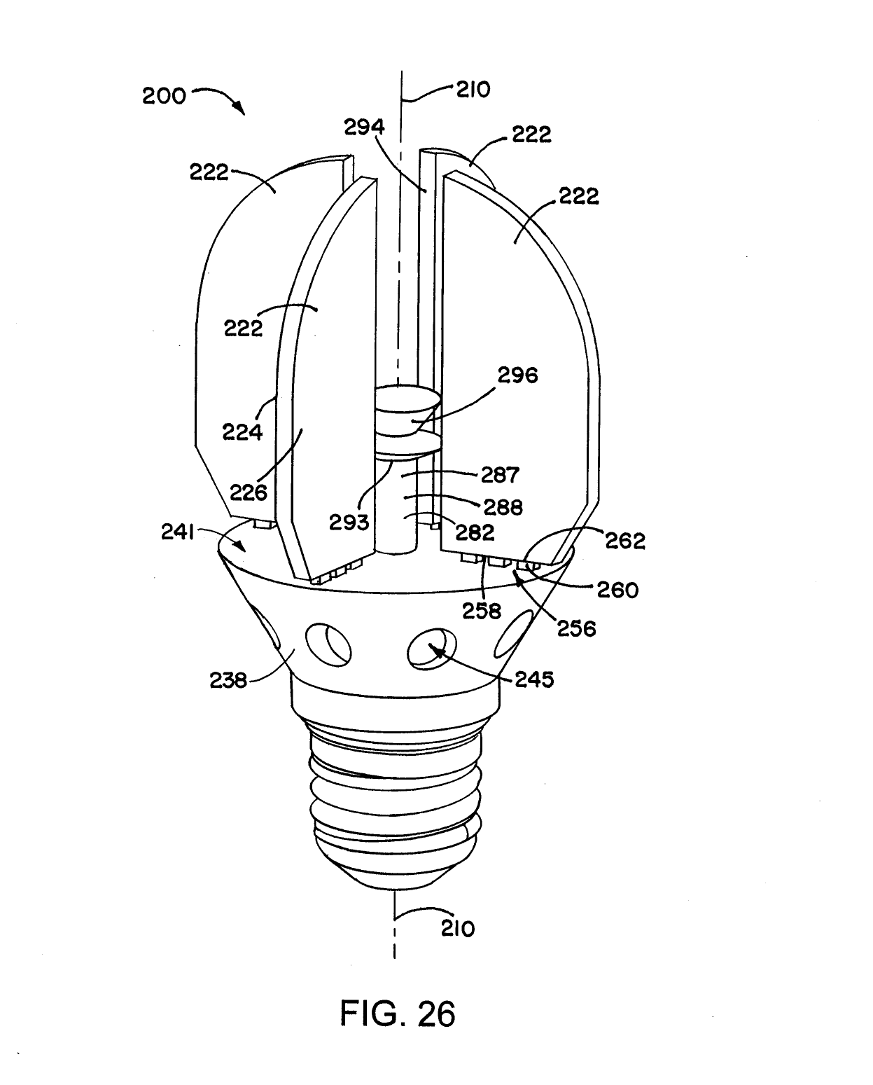

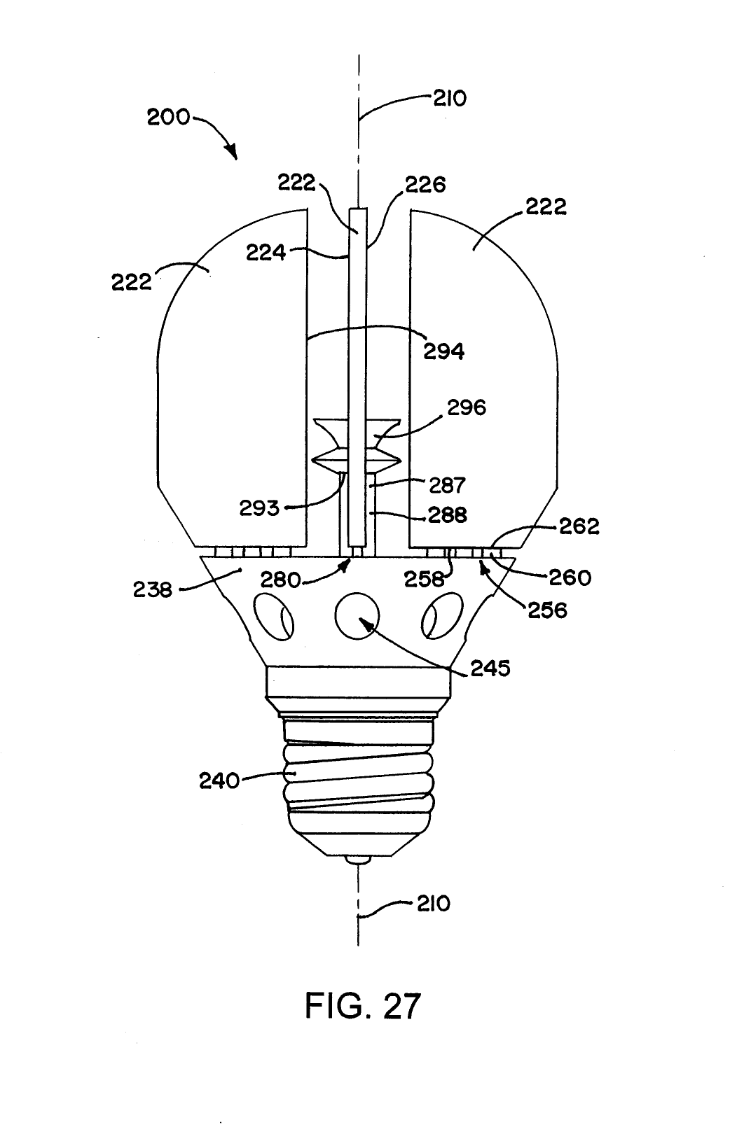

FIGS. 26 and 27 show another embodiment of the light bulb 200 having separate radially extending light guides (FIGS. 13, 14, and 20). The light bulb 200 additionally includes a light redirecting optic 296 at the distal end 293 of a light pipe 287. Light input to the light pipe 287 and incident the light redirecting optic 296 is output from the light redirecting optic 296 in a direction having a radial component. In some embodiments in which light source 280 generates light of a different color from light sources 260, the light extracting optic is configured to output the light received from the light pipe 287 with a light ray angle distribution similar to the light ray angle distribution of the light output from the light guides 222. In other embodiments in which light source 280 generates light of a similar color to light sources 260, the light extracting optic is configured to output the light received from the light pipe 287 with a light ray angle distribution different from the light ray angle distribution of the light output from the light guides 222.

In this disclosure, the phrase “one of” followed by a list is intended to mean the elements of the list in the alternative. For example, “one of A, B and C” means A or B or C. The phrase “at least one of” followed by a list is intended to mean one or more of the elements of the list in the alternative. For example, “at least one of A, B and C” means A or B or C or (A and B) or (A and C) or (B and C) or (A and B and C).

1. A light bulb, comprising:
an axial heat sink comprising an outer major surface extending between a first end and a second end, the axial heat sink defining a longitudinal axis;
planar light guides disposed about the axial heat sink, each of the light guides comprising a respective light input edge adjacent the outer major surface of the axial heat sink, respective opposed major surfaces extending from the light input edge in a direction having a radial component with respect to the longitudinal axis, and light extracting elements at least one of the opposed major surfaces to extract light through at least one of the opposed major surfaces of the light guide; and
for each light guide, a respective light source mounted to the axial heat sink to edge light the light guide such that light from the light source propagates in the light guide by total internal reflection at the opposed major surfaces.

2. The light bulb of claim 1, wherein the major surfaces of at least one of the light guides also extends in a direction having an axial component.

3.-5. (canceled)

6. The light bulb of claim 1, wherein the axial heat sink is one of cylindrical in shape, conical in shape, pyramidal in shape, frustoconical in shape, frustopyramidal in shape, prism-shaped, bell-shaped, hourglass-shaped, or bulbous in shape.

7. (canceled)

8. (canceled)

9. The light bulb of claim 1, wherein the axial heat sink is configured as an open-ended hollow body surrounding an internal volume and additionally comprises an inner major surface.

10.-15. (canceled)

16. The light bulb of claim 1, additionally comprising a housing coupled to the first end of the axial heat sink.

17. (canceled)

18. (canceled)

19. The light bulb of claim 16, wherein:
each of the light sources is a first light source; and
the light bulb additionally comprises, for each light guide, a second light source mounted to the housing to output light in a direction having an axial component to edge light the light guide.

20. The light bulb of claim 16, additionally comprising a reflector extending from the housing and disposed around the light guides.

21. (canceled)

22. (canceled)

23. The light bulb of claim 1, additionally comprising:
a first housing at a first end of the axial heat sink and a second housing at a second end of the axial heat sink; and
a first bi-pin base coupled to the first housing, and a second bi-pin base coupled to the second housing, the first bi-pin base and the second bi-pin base each configured to mechanically mount the light bulb and receive electrical power.

24.-42. (canceled)

43. A light bulb, comprising:
a housing comprising a mounting surface, a normal to the surface defining a longitudinal axis;
planar light guides coupled to the housing, each of the light guides comprising respective opposed major surfaces extending in a direction having a radial component with respect to the longitudinal axis, a light input edge extending between the major surfaces at an end of the light guide proximate the housing, and light extracting elements at least one of the major surfaces to extract light from the light guide through at least one of the major surfaces;
for each light guide, a respective light source mounted to the housing adjacent the light input edge of the light guide to edge light the light guide such that light from the light source propagates in the light guide by total internal reflection at the opposed major surfaces of the light guide.

44. The light bulb of claim 43, wherein the major surfaces of at least one of the light guides also extend in a direction having an axial component.

45.-47. (canceled)

48. The light bulb of claim 43, wherein the light guides are joined at, and extend radially outward from, a common node.

49.-53. (canceled)

54. The light bulb of claim 43, wherein the light guides are rotatable relative to the housing about the longitudinal axis.

55. The light bulb of claim 54, wherein:
in a first state, the light guides are positioned such that each light source is adjacent the light input edge of the respective light guide to edge light the light guide; and
in a second state, the light guides are positioned such that each light source is not adjacent the light input edge of the respective light guide and light emitted from the light source is emitted from the light bulb without edge lighting the light guide.

56. The light bulb of claim 55, additionally comprising lens elements aligned with the light sources when the light guide is in the second state.

57. The light bulb of claim 54, additionally comprising a rotatable spectrum adjuster interposed between the light sources and the light guide.

58.-62. (canceled)

63. The light bulb of claim 43, wherein:
each of the light sources is a first light source; and
the light bulb additionally comprises a second light source mounted to the housing adjacent the end of the light guide to edge light the light guides such that light from the second light source propagates in the light guides by total internal reflection at the opposed major surfaces of the light guides.

64. The light bulb of claim 63, wherein the first light source emits light of a first spectrum, the second light source emits light of a second spectrum, different from the first spectrum, and the light of the second spectrum mixes with the light of the first spectrum so that light output by the light bulb has a spectrum that is a combination of the first spectrum and the second spectrum.

65.-67. (canceled)

68. The light bulb of claim 63, wherein the light guide additionally comprises an optical element adjacent the additional light source, the optical element configured to distribute the light input to the light guide from the second light source among the light guides.

69.-71. (canceled)

72. The light bulb of claim 63, wherein:
the light input edge of each light guide is a first light input edge; and
the light bulb additionally comprises an auxiliary light guide end lit by the second light source, the auxiliary light guide comprising light extracting elements to extract light from the auxiliary light guide, and to direct the extracted light to a second light input edge of each light guide, the second light input edge being different from the first light input edge.

73. (canceled)

74. The light bulb of claim 63, additionally comprising a light redirecting optic coupled the second light source to redirect light from the additional light source in a radial direction.

75.-78. (canceled)
